(19) United States
(12) Patent Application Publication
(10) Pub. No.: US 2023/0002132 A1
(43) Pub. Date: Jan. 5, 2023

(54) WATER SOLUBLE NONWOVEN WEBS FOR PACKAGING HARSH CHEMICALS

(71) Applicant: MONOSOL, LLC, Merrillville, IN (US)

(72) Inventors: VICTORIA BRIDEWELL, Merrillville, IN (US); Jonathon Knight, LAPORTE, IN (US)

(73) Assignee: MONOSOL, LLC, Merrillville, IN (US)

(21) Appl. No.: 17/764,035

(22) PCT Filed: Sep. 30, 2020
(86) PCT No.: PCT/US2020/053601

§ 371 Date: Mar. 25, 2022

Related U.S. Application Data
(60) Provisional application No. 62/908,582, filed on Sep. 30, 2019.

(51) Int. Cl. B65D 65/46; B65D 65/42; B65D 85/84; D04H 1/4309; D04H 1/4382; C11D 3/395; C11D 17/04

(52) U.S. Cl. CPC B65D 65/46; B65D 65/42; B65D 85/84; D04H 1/4309; D04H 1/43835; C11D 3/3953; C11D 17/042; D10B 2401/024; D10B 2505/10

(57) ABSTRACT

Disclosed herein are nonwoven webs and/or unit dose articles comprising a sulfonate modified PVOH fiber forming materials and/or a blend of fiber forming materials comprising polyvinylpyrrolidone and a sulfonate modified PVOH, carboxyl modified PVOH, or both. Also disclosed herein, are said unit dose articles comprising a composition including a harsh chemical.

### CROSS-REFERENCE TO RELATED APPLICATIONS

This application claims the benefit under 35 U.S.C. § 119(e) of U.S. Provisional Patent Application No. 62/908,582, filed on Sep. 30, 2019, the entirety of which is hereby incorporated by reference.

### FIELD OF THE INVENTION

The present disclosure relates generally to water soluble nonwoven web and related compositions. More particularly, the disclosure relates to water soluble nonwoven web for packaging harsh chemical compositions.

### BACKGROUND

Water soluble packaging materials are commonly used to simplify dispersing, pouring, dissolving and dosing of a material to be delivered. Traditional packaging materials include water soluble films and pouches made therefrom are commonly used to package compositions such as laundry, dish detergents or harsh chemicals. A consumer can directly add the pouched composition to water. Advantageously, this provides for accurate dosing while eliminating the need for the consumer to measure the composition. Traditional water soluble films can interact with the pouch components (e.g., harsh chemicals) or environmental moisture, which can affect the properties of the film, for example, the solubility of the film can decrease over time when stored in contact with such chemicals, resulting in undesirable residue remaining after a dosing and/or the mechanical properties of the film may deteriorate over time. In another type of problem, water soluble films may discolor when stored in contact with harsh chemicals. In another type of problem, water soluble films prepared from water soluble polymers may stick to processing equipment and/or other water soluble films. Such problems may particularly arise when the film is formed into pouches and the pouches are stored together in secondary packaging. In addition, some currently marketed pouches made of water soluble polymeric films have an unpleasant rubbery or plastic-like feel when handled by the consumer. In another type of problem, when water soluble pouches are provided to, e.g., bulk water, the water soluble pouches may release the contents in such a way that a localized concentration of contents is provided, rather than providing a more homogeneous distribution of the contents throughout the bulk solution.

Thus, there exists a need in the art for water soluble packaging that is pleasant to handle, quickly releases the pouch contents to provide a more homogeneous distribution, and which can remain water soluble after storing in contact with the pouch contents while having a reduced tendency to stick to other water soluble packaging.

### SUMMARY

One aspect of the disclosure provides unit dose articles comprising a packet comprising an outer wall, the outer wall having an exterior surface and an interior surface defining an interior pouch volume, the outer wall comprising a nonwoven web comprising a plurality of fibers comprising a sulfonate modified PVOH fiber forming material comprising a sulfonated anionic monomer unit wherein the sulfonate modified PVOH fiber forming material has a degree of hydrolysis of at least 95% and the sulfonated anionic monomer is present in an amount in a range of about 1 mol % to about 5 mol %; and a composition contained in the interior pouch volume.

Another aspect of the disclosure provides unit dose articles comprising a packet comprising an outer wall, the outer wall having an exterior surface and an interior surface defining an interior pouch volume, the outer wall comprising a nonwoven web comprising a plurality of fibers comprising a blend of fiber forming materials comprising (i) polyvinylpyrrolidone, and (ii) a sulfonate modified polyvinyl alcohol (PVOH), a carboxyl modified PVOH, or both; and a composition contained in the interior pouch volume.

Another aspect of the disclosure provides unit dose articles of the disclosure, wherein a pool and/or water-treatment composition is contained in the interior pouch volume, the pool and/or water-treatment composition comprises an oxidant, and the concentration of the oxidant in the pool and/or water treatment composition is in a range of 50% to 100% by weight; and wherein the oxidant comprises calcium hypochlorite, and the packet optionally comprises a first coating comprising an acid scavenger provided on at least a portion of the interior surface of the outer wall.

Another aspect of the disclosure provides unit dose articles of the disclosure, wherein a pool and/or water-treatment composition is contained in the interior pouch volume, the pool and/or water-treatment composition comprises an oxidant, and the concentration of the oxidant in the pool and/or water treatment composition is in a range of 50% to 100% by weight; and wherein the oxidant comprises trichloroisocyanuric acid, and the packet optionally comprises a first coating comprising an acid scavenger provided on at least a portion of the interior surface of the outer wall.

Another aspect of the disclosure provides processes for dosing a composition to bulk water comprising the steps of contacting with the bulk water a unit dose article according to the disclosure.

For the compositions described herein, optional features, including but not limited to components and compositional ranges thereof, fiber forming materials, multiple layer constructions, fiber geometries, and/or mechanical properties are contemplated to be selected from the various aspects and embodiments provided herein.

Further aspects and advantages will be apparent to those of ordinary skill in the art from a review of the following detailed description. While the fibers, nonwoven webs, unit dose articles, and compositions, of the disclosure are susceptible of embodiments in various forms, the description hereafter includes specific embodiments with the understanding that the disclosure is illustrative and is not intended to limit the disclosure to the specific embodiments described herein.

### DETAILED DESCRIPTION

In the disclosure presented herein, one aspect provides unit dose articles comprising a packet comprising an outer wall, the outer wall having an exterior surface and an interior surface defining an interior pouch volume, the outer wall comprising a nonwoven web, and a composition contained in the interior pouch volume. In embodiments, the nonwoven web comprises a plurality of fibers comprising a sulfonate modified polyvinyl alcohol (“PVOH”) fiber forming material comprising a sulfonated anionic monomer unit. In embodiments, the sulfonate modified PVOH fiber forming material has a degree of hydrolysis of at least 95%. In embodiments, the sulfonated anionic monomer is present in an amount in a range of about 1 mol % to about 5 mol %.

Another aspect of the disclosure provides unit dose articles comprising a packet comprising an outer wall, the outer wall having an exterior surface and an interior surface defining an interior pouch volume, the outer wall comprising a nonwoven web, and a composition contained in the interior pouch volume. In embodiments, the nonwoven web comprises a plurality of fibers comprising a blend of fiber forming materials. In embodiments, the blend of fiber forming materials comprises (i) polyvinylpyrrolidone, and (ii) a sulfonate modified PVOH, a carboxyl modified PVOH, or both.

In the disclosure presented herein, one aspect provides a water soluble nonwoven web comprising a plurality of fibers. In embodiments, the plurality of fibers can comprise a blend of fiber forming materials comprising a carboxyl modified polyvinyl alcohol, and a sulfonate modified polyvinyl alcohol, polyvinylpyrrolidone, or both, wherein the weight ratio of the carboxyl modified polyvinyl alcohol fiber forming material to the sulfonate and/or polyvinylpyrrolidone fiber forming materials is about 3:1 to about 19:1. In embodiments, the plurality of fibers can comprise a blend of fibers comprising a fiber having a carboxyl modified polyvinyl alcohol fiber forming material, and a fiber having a sulfonate modified polyvinyl alcohol fiber forming material, a fiber having a polyvinylpyrrolidone fiber forming material, or both types of fibers, wherein the weight ratio of the carboxyl modified polyvinyl alcohol fiber forming material to the sulfonate and/or polyvinylpyrrolidone fiber forming materials is about 3:1 to about 19:1. In embodiments, the plurality of fibers can comprise a blend of fibers comprising a first fiber comprising a carboxyl modified polyvinyl alcohol fiber forming material, a sulfonate modified polyvinyl alcohol fiber forming material, or a polyvinyl pyrrolidone fiber forming material, and a second fiber comprising a blend of fiber forming materials comprising carboxyl modified polyvinyl alcohol fiber forming material, a sulfonate modified polyvinyl alcohol fiber forming material, a polyvinyl pyrrolidone fiber forming material, or a combination thereof, wherein the weight ratio of the carboxyl modified polyvinyl alcohol fiber forming material to the sulfonate and/or polyvinylpyrrolidone fiber forming materials is about 3:1 to about 19:1.

Harsh chemicals include chemical species that are highly acidic or alkaline, compounds that have a positive standard electrode potential, and/or compounds that are very hygroscopic such that they will desiccate moisture containing materials.

Another aspect of the disclosure provides a water soluble unit dose article comprising an outer wall, the outer wall having an exterior surface and an interior surface defining an interior pouch volume, the outer wall comprising a water soluble nonwoven web as described herein, and a composition contained in the interior pouch volume. In embodiments, the composition can comprise a harsh chemical.

The water soluble unit dose article according to the disclosure can be designed to provide one or more advantages, for example, retaining desirable nonwoven web properties in the presence of harsh chemicals, such as elasticity and solubility, resistance to degrading in the presence of harsh chemicals, resistance to coloration, improved hand feel relative to pouches made from a water soluble film, reduced tendency to stick to other pouches and/or secondary packages relative to pouches prepared from a water soluble film, and/or provide a more homogenous release and distribution of contents to bulk water compared to pouches prepared from a water soluble film.

All percentages, parts and ratios referred to herein are based upon the total dry weight of the fiber composition, nonwoven web composition or total weight of the packet content composition of the present disclosure, as the case may be, and all measurements made are at about 25° C., unless otherwise specified. All such weights as they pertain to listed ingredients are based on the active level and therefore do not include carriers or by-products that may be included in commercially available materials, unless otherwise specified.

All ranges set forth herein include all possible subsets of ranges and any combinations of such subset ranges. By default, ranges are inclusive of the stated endpoints, unless stated otherwise. Where a range of values is provided, it is understood that each intervening value between the upper and lower limit of that range and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also contemplated to be part of the disclosure.

It is expressly contemplated that for any number value described herein, e.g. as a parameter of the subject matter described or part of a range associated with the subject matter described, an alternative which forms part of the description is a functionally equivalent range surrounding the specific numerical value (e.g. for a dimension disclosed as “40 mm” an alternative embodiment contemplated is “about 40 mm”).

As used herein and unless specified otherwise, the term “nonwoven web” refers to a web or sheet comprising, consisting of, or consisting essentially of fibers arranged (e.g., by a carding process) and bonded to each other. Further, as used herein, “nonwoven web” includes any structure including a nonwoven web or sheet, including, for example, a nonwoven web or sheet having a film laminated to a surface thereof. Methods of preparing nonwoven webs from fibers are well known in the art, for example, as described in Nonwoven Fabrics Handbook, prepared by Ian Butler, edited by Subhash Batra et al., Printing by Design, 1999, herein incorporated by reference in its entirety. As used herein and unless specified otherwise, the term “film” refers to a continuous film or sheet, e.g., prepared by a casting or extrusion process.

As used herein and unless specified otherwise, the term “water soluble” refers to any fiber, nonwoven web, or film having a dissolution time of 300 seconds or less at a specified temperature as determined according to MSTM-205 as set forth herein. For example, the dissolution time optionally can be 200 seconds or less, 100 seconds or less, 60 seconds or less, or 30 seconds or less at a temperature of about 80° C., about 70° C., about 60° C., about 50° C., about 40° C., about 20° C., or about 10° C. In embodiments, wherein the dissolution temperature is not specified, the water soluble fiber, nonwoven web, or nonwoven composite article has a dissolution time of 300 seconds or less at a temperature no greater than about 80° C. As used herein and unless specified otherwise, the term “cold water soluble” refers to any fiber, nonwoven web, or nonwoven composite article having a dissolution time of 300 seconds or less at 10° C. as determined according to MSTM-205. For example, the dissolution time optionally can be 200 seconds or less, 100 seconds or less, 60 seconds or less, or 30 seconds at 10° C. In embodiments, “water soluble film” means that at a thickness of 1.5 mil, the film dissolves in 300 seconds or less at a temperature no greater than 80° C. For example, a 1.5 mil (about 38 μm) thick water soluble film can have a dissolution time of 300 seconds or less, 200 seconds or less, 100 seconds or less, 60 seconds or less, or 30 seconds or less at a temperature of about 70° C., about 60° C., about 50° C., about 40° C., about 30° C., about 20° C., or about 10° C. according to MSTM-205.

As used herein, the terms packet(s) and pouch(es) should be considered interchangeable. In certain embodiments, the terms packet(s) and pouch(es), respectively, are used to refer to a container made using the nonwoven web, and to a fully-sealed container preferably having a material sealed therein, e.g., in the form of a measured dose delivery system. The sealed pouches can be made from any suitable method, including such processes and features such as heat sealing, solvent welding, and adhesive sealing (e.g., with use of a water soluble adhesive).

As used herein and unless specified otherwise, the terms “wt. %” and “wt %” are intended to refer to the composition of the identified element in “dry” (non-water) parts by weight of the entire nonwoven web, including residual moisture in the nonwoven web, or parts by weight of the entire composition or coating, as the case may be depending on context.

As used herein and unless specified otherwise, the term “PHR” (“phr”) is intended to refer to the composition of the identified element in parts per one hundred parts water soluble polymer resin(s) (whether PVOH or other polymer resins, unless specified otherwise) in the water soluble nonwoven web, or a solution used to make the nonwoven web.

“Comprising” as used herein means that various components, ingredients or steps that can be conjointly employed in practicing the present disclosure. Accordingly, the term “comprising” encompasses the more restrictive terms “consisting essentially of” and “consisting of.” The present compositions can comprise, consist essentially of, or consist of any of the required and optional elements disclosed herein. For example, a thermoformed packet can “consist essentially of” a nonwoven web described herein for use of its thermoforming characteristics, while including a non-thermoformed nonwoven web (e.g., lid portion), and optional markings on the nonwoven web, e.g. by inkjet printing. The disclosure illustratively disclosed herein suitably may be practiced in the absence of any element or step which is not specifically disclosed herein.

The nonwoven webs, pouches, and related methods of making and use are contemplated to include embodiments including any combination of one or more of the additional optional elements, features, and steps further described below, unless stated otherwise.

The nonwoven web can be made by any suitable method, including carding, as is well known in the art as described in Nonwoven Fabrics Handbook, prepared by Ian Butler, edited by Subhash Batra et al., Printing by Design, 1999, herein incorporated by reference in its entirety. Methods of forming containers, such as pouches, from nonwovens are known in the art. The nonwoven web can be used to form a container (pouch) by any suitable process, including vertical form, fill, and sealing (VFFS), or thermoforming. The nonwoven web can be sealed by any suitable process including, for example, solvent sealing or heat sealing of nonwoven web layers, e.g., around a periphery of a container. Advantageously, the nonwoven webs of the disclosure can demonstrate preferential shrinking in the presence of heat and/or water (e.g., humidity). Accordingly, the nonwoven webs can be heat and/or water shrunk when formed into packets. The pouches can be used for dosing materials to be delivered into bulk water, for example.

The nonwoven webs, pouches, and related methods of use are contemplated to include embodiments including any combination of one or more of the additional optional elements, features, and steps further described below, unless stated otherwise.

Water Soluble Fiber Forming Materials

In general, the water soluble nonwoven web can include a plurality of fibers including a single fiber forming material or a blend of fiber forming materials. In embodiments, the fiber forming materials are water soluble. In embodiments, the fibers are water soluble.

In general, the fibers of the disclosure include at least one polyvinyl alcohol fiber forming material. Polyvinyl alcohol is a synthetic polymer generally prepared by the alcoholysis, usually termed hydrolysis or saponification, of polyvinyl acetate. Fully hydrolyzed PVOH, where virtually all the acetate groups have been converted to alcohol groups, is a strongly hydrogen-bonded, highly crystalline polymer which dissolves only in hot water—greater than about 140° F. (about 60° C.). If a sufficient number of acetate groups are allowed to remain after the hydrolysis of polyvinyl acetate, that is the PVOH polymer is partially hydrolyzed, then the polymer is more weakly hydrogen-bonded, less crystalline, and is generally soluble in cold water—less than about 50° F. (about 10° C.). As such, the partially hydrolyzed polymer is a vinyl alcohol-vinyl acetate copolymer that is a PVOH copolymer, but is commonly referred to as PVOH.

The polyvinyl alcohol can be a modified polyvinyl alcohol, for example, a copolymer. The modified polyvinyl alcohol can include a co-polymer or higher polymer (e.g., ter-polymer) including one or more monomers in addition to the vinyl acetate/vinyl alcohol groups. Optionally, the modification is neutral, e.g., provided by an ethylene, propylene, N-vinylpyrrolidone or other non-charged monomer species. Optionally, the modification is a cationic modification, e.g., provided by a positively charged monomer species. Optionally, the modification is an anionic modification. Thus, in some embodiments, the polyvinyl alcohol includes an anionic modified polyvinyl alcohol. An anionic modified polyvinyl alcohol can include a partially or fully hydrolyzed PVOH copolymer that includes an anionic monomer unit, a vinyl alcohol monomer unit, and optionally a vinyl acetate monomer unit (i.e., when not completely hydrolyzed). In some embodiments, the PVOH copolymer can include two or more types of anionic monomer units. General classes of anionic monomer units which can be used for the PVOH copolymer include the vinyl polymerization units corresponding to sulfonic acid vinyl monomers and their esters, monocarboxylic acid vinyl monomers, their esters and anhydrides, dicarboxylic monomers having a polymerizable double bond, their esters and anhydrides, and alkali metal salts of any of the foregoing. Examples of suitable anionic monomer units include the vinyl polymerization units corresponding to vinyl anionic monomers including vinyl acetic acid, maleic acid, monoalkyl maleate, dialkyl maleate, maleic anhydride, fumaric acid, monoalkyl fumarate, dialkyl fumarate, itaconic acid, monoalkyl itaconate, dialkyl itaconate, citraconic acid, monoalkyl citraconate, dialkyl citraconate, citraconic anhydride, mesaconic acid, monoalkyl mesaconate, dialkyl mesaconate, glutaconic acid, monoalkyl glutaconate, dialkyl glutaconate, glutaconic anhydride, alkyl acrylates, alkyl alkacrylates, vinyl sulfonic acid, allyl sulfonic acid, ethylene sulfonic acid, 2-acrylamido-1-methyl propane sulfonic acid, 2-acrylamide-2-methylpropanesulfonic acid (AMPS), 2-methylacrylamido-2-methylpropanesulfonic acid, 2-sulfoethyl acrylate, alkali metal salts of the foregoing (e.g., sodium, potassium, or other alkali metal salts), esters of the foregoing (e.g., methyl, ethyl, or other C₁-C₄ or C₆ alkyl esters), and combinations of the foregoing (e.g., multiple types of anionic monomers or equivalent forms of the same anionic monomer). In some embodiments, the PVOH copolymer can include two or more types of monomer units selected from neutral, anionic, and cationic monomer units.

The level of incorporation (degree of modification) of the one or more anionic monomer units in the PVOH copolymers is not particularly limited. In embodiments, the one or more anionic monomer units are present in the PVOH copolymer in an amount in a range of about 1 mol. % or 2 mol. % to about 6 mol. % or 10 mol. % (e.g., at least 1.0, 1.5, 2.0, 2.5, 3.0, 3.5, or 4.0 mol. % and/or up to about 3.0, 4.0, 4.5, 5.0, 6.0, 8.0, or 10 mol. % in various embodiments). In embodiments, the one or more anionic monomer units are present in the PVOH copolymer in an amount in a range of about 1 mol. % to 10 mol %, or about 1 mol % to 8 mol %, or about 1 mol % to 5 mol %, about 2 mol. % to about 6 mol. %, about 3 mol. % to about 5 mol. %, or about 1 mol. % to about 3 mol. %.

The degree of hydrolysis (DH) of the PVOH homopolymers and PVOH copolymers included in the water soluble fibers and nonwoven webs of the present disclosure can be in a range of about 75% to about 99.9% (e.g., about 79% to about 92%, about 80% to about 90%, about 88% to 92%, about 86.5% to about 89%, or about 88%, 90% or 92% such as for cold-water soluble compositions; about 90% to about 99%, about 92% to about 99%, about 95% to about 99%, about 98% to about 99%, about 98% to about 99.9%, about 96%, about 98%, about 99%, or greater than 99%). The DH, while specifically is a measure of the amount of acetates removed from the polyvinyl acetate polymer (e.g. via hydrolysis, saponification), it is most commonly used to understand the amount of acetate remaining on the PVOH polymer or copolymer. The acetate groups form the amorphous or non-crystalline regions of the PVOH copolymer. Therefore, it can be stated as an approximation, the higher the DH, the relatively higher is the crystallinity of the PVOH copolymer or blends of the PVOH copolymer. When a PVOH resin is described as having (or not having) a particular DH, unless specified otherwise, it is intended that the specified DH is the average DH for the PVOH resin.

In general, as the degree of hydrolysis is reduced, a fiber or nonwoven web made from the polymer will have reduced mechanical strength but faster solubility at temperatures below about 20° C. As the degree of hydrolysis increases, a fiber or nonwoven web made from the polymer will tend to be mechanically stronger and the thermoformability will tend to decrease. The degree of hydrolysis of the PVOH can be chosen such that the water-solubility of the polymer is temperature dependent, and thus the solubility of a fiber and/or nonwoven web made from the polymer and additional ingredients is also influenced. In one option the nonwoven web is cold water soluble. For a co-poly(vinyl acetate vinyl alcohol) polymer that does not include any other monomers (e.g., a homopolymer not copolymerized with an anionic monomer) a cold water soluble fiber or nonwoven web, soluble in water at a temperature of less than 10° C., can include PVOH with a degree of hydrolysis in a range of about 75% to about 90%, or in a range of about 80% to about 90%, or in a range of about 85% to about 90%. In another option the fiber or nonwoven web is hot water soluble. For a co-poly(vinyl acetate vinyl alcohol) polymer that does not include any other monomers (e.g., a homopolymer not copolymerized with an anionic monomer) a hot water soluble fiber or nonwoven web, soluble in water at a temperature of at least about 60° C., can include PVOH with a degree of hydrolysis of at least about 98%.

The degree of hydrolysis of a polymer blend can also be characterized by the arithmetic weighted, average degree of hydrolysis (H̅°̅). For example, H̅°̅ for a PVOH polymer that includes two or more PVOH polymers is calculated by the formula H̅°̅=Σ(Wi·Hᵢ) where Wᵢ is the weight percentage of the respective PVOH polymer and Hᵢ is the respective degrees of hydrolysis. When a polymer is referred to as having a specific degree of hydrolysis, the polymer can be a single polyvinyl alcohol polymer having the specified degree of hydrolysis or a blend of polyvinyl alcohol polymers having an average degree of hydrolysis as specified.

The viscosity of a PVOH polymer (μ) is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. All viscosities specified herein in Centipoise (cP) should be understood to refer to the viscosity of 4% aqueous polyvinyl alcohol solution at 20° C., unless specified otherwise. Similarly, when a polymer is described as having (or not having) a particular viscosity, unless specified otherwise, it is intended that the specified viscosity is the average viscosity for the polymer, which inherently has a corresponding molecular weight distribution, i.e. the weighted natural log average viscosity as described below. It is well known in the art that the viscosity of PVOH polymers is correlated with the weight average molecular weight (M̅w) of the PVOH polymer, and often the viscosity is used as a proxy for the M̅w.

In embodiments, the PVOH resin may have a viscosity of about 1.0 to about 50.0 cPs, about 1.0 to about 40.0 cPs, or about 1.0 to about 30.0 cPs, for example about 4 cPs, 8 cPs, 15 cPs, 18 cPs, 23 cPs, or 26 cPs. In embodiments, the PVOH copolymers may have a viscosity of about 1.0 to about 30.0 cPs for example, about 1 cPs, 1.5 cPs, 2 cPs, 2.5 cPs, 3 cPs, 3.5 cPs, 4 cPs, 4.5 cPs, 5 cPs, 5.5 cPs, 6 cPs, 6.5 cPs, 7 cPs, 7.5 cPs, 8 cPs, 8.5 cPs, 9 cPs, 9.5 cPs, 10 cPs, 11 cPs, 12 cPs, 13 cPs, 14 cPs, 15 cPs, 17.5 cPs, 18 cPs, 19 cPs, 20 cPs, 21 cPs, 22 cPs, 23 cPs, 24 cPs, 25 cPs, 26 cPs, 27 cPs, 28 cPs, 29 cPs, 30 cPs, 31 cPs, 32 cPs, 33 cPs, 34 cPs, or 35 cPs. In embodiments, the PVOH copolymers may have a viscosity of about 21 cPs to 26 cPs. In embodiments, the PVOH copolymers can have a viscosity of about 5 cPs to about 14 cPs.

Polyvinyl alcohols can be subject to changes in solubility characteristics. The acetate group in the co-poly(vinyl acetate vinyl alcohol) polymer (PVOH homopolymer) is known by those skilled in the art to be hydrolysable by either acid or alkaline hydrolysis. As the degree of hydrolysis increases, a polymer composition made from the PVOH homopolymer will have increased mechanical strength but reduced solubility at lower temperatures (e.g., requiring hot water temperatures for complete dissolution). Accordingly, exposure of a PVOH homopolymer to an alkaline environment can transform the polymer from one which dissolves rapidly and entirely in a given aqueous environment (e.g., a cold water medium) to one which dissolves slowly and/or incompletely in the aqueous environment, potentially resulting in undissolved polymeric residue.

PVOH copolymers with pendant carboxyl groups, such as, for example, maleate modified PVOH, can form lactone rings between neighboring pendant carboxyl and alcohol groups, thus reducing the water solubility of the PVOH copolymer. In the presence of a strong base, the lactone rings can open over the course of several weeks at relatively warm (ambient) and high humidity conditions (e.g., via lactone ring-opening reactions to form the corresponding pendant carboxyl and alcohol groups with increased water solubility). Thus, contrary to the effect observed with PVOH homopolymers, it is believed that such a PVOH copolymer can become more soluble due to chemical interactions between the polymer and an alkaline composition inside the pouch during storage.

Specific sulfonates and derivatives thereof having polymerizable vinyl bonds can be copolymerized with vinyl acetate to provide cold-water soluble PVOH polymers which are stable in the presence of strong bases. The base-catalyzed alcoholysis products of these copolymers, which can be used in the formulation of water soluble fibers, are vinyl alcohol-sulfonate salt copolymers which are rapidly soluble. The sulfonate group in the PVOH copolymer can revert to a sulfonic acid group in the presence of hydrogen ions, but the sulfonic acid group still provides excellent cold-water solubility of the polymer. In embodiments, vinyl alcohol-sulfonate salt copolymers contain no residual acetate groups (i.e., are fully hydrolyzed) and therefore are not further hydrolysable by either acid or alkaline hydrolysis. Generally, as the amount of modification increases, the water solubility increases, thus sufficient modification via sulfonate or sulfonic acid groups inhibit hydrogen bonding and crystallinity, enabling solubility in cold water. In the presence of acidic or basic species, the copolymer is generally unaffected, with the exception of the sulfonate or sulfonic acid groups, which maintain excellent cold water solubility even in the presence of acidic or basic species. Examples of suitable sulfonic acid comonomers (and/or their alkali metal salt derivatives) include vinyl sulfonic acid, allyl sulfonic acid, ethylene sulfonic acid, 2-acrylamido-1-methylpropanesulfonic acid, 2-acrylamido-2-methylpropanesufonic acid, 2-methacrylamido-2-methylpropanesulfonic acid and 2-sulfoethyl acrylate, with the sodium salt of 2-acrylamido-2-methylpropanesulfonic acid (AMPS) being a preferred comonomer.

The water soluble polymers, whether polyvinyl alcohol polymers or otherwise, can be blended. When the polymer blend includes a blend of polyvinyl alcohol polymers, the PVOH polymer blend can include a first PVOH polymer (“first PVOH polymer”) which can include a PVOH homopolymer or a PVOH copolymer including one or more types of anionic monomer units (e.g., a PVOH ter- (or higher co-) polymer) and a second PVOH polymer (“second PVOH polymer”) which can include a PVOH homopolymer or a PVOH copolymer including one or more types of anionic monomer units (e.g., a PVOH ter- (or higher co-) polymer). In some aspects, the PVOH polymer blend includes only the first PVOH polymer and the second PVOH polymer (e.g., a binary blend of the two polymers). Alternatively or additionally, the PVOH polymer blend or a fiber or nonwoven web made therefrom can be characterized as being free or substantially free from other polymers (e.g., other water soluble polymers generally, other PVOH-based polymers specifically, or both). As used herein, “substantially free” means that the first and second PVOH polymers make up at least 95 wt. %, at least 97 wt. %, or at least 99 wt. % of the total amount of water soluble polymers in the water soluble fiber or nonwoven web. In other aspects, the water soluble fiber or nonwoven web can include one or more additional water soluble polymers. For example, the PVOH polymer blend can include a third PVOH polymer, a fourth PVOH polymer, a fifth PVOH polymer, etc. (e.g., one or more additional PVOH homopolymers or PVOH copolymers, with or without anionic monomer units). For example, the water soluble nonwoven web can include at least a third (or fourth, fifth, etc.) water soluble polymer which is other than a PVOH polymer (e.g., other than PVOH homopolymers or PVOH copolymers, with or without anionic monomer units).

Water soluble polymers other than a PVOH polymer can include, but are not limited to, polyacrylate, water soluble acrylate copolymer, polyvinyl pyrrolidone, polyethyleneimine, pullulan, water soluble natural polymer including, but not limited to, guar gum, gum Acacia, xanthan gum, carrageenan, and starch, water soluble polymer derivatives including, but not limited to, modified starches, ethoxylated starch, and hydroxypropylated starch, copolymers of the forgoing and combinations of any of the foregoing. Yet other water soluble polymers can include polyalkylene oxides, polyacrylamides, polyacrylic acids and salts thereof, celluloses, cellulose ethers, cellulose esters, cellulose amides, polyvinyl acetates, polycarboxylic acids and salts thereof, polyaminoacids, polyamides, gelatines, methylcelluloses, carboxymethylcelluloses and salts thereof, dextrins, ethylcelluloses, hydroxyethyl celluloses, hydroxypropyl methylcelluloses, maltodextrins, polymethacrylates, and combinations of any of the foregoing. Such water soluble polymers, whether PVOH or otherwise are commercially available from a variety of sources. In embodiments, the fiber forming material can include a carboxyl modified polyvinyl alcohol. In embodiments, the carboxyl modified PVOH comprises a maleate monomer unit selected from the group consisting of monomethyl maleate, maleic acid, maleic anhydride, alkali salts thereof, and a combination thereof. Thus, in embodiments, the carboxyl modified PVOH comprises a maleate modified PVOH. As used herein, and unless specified otherwise, a “maleate modified PVOH” refers to a polyvinyl alcohol including monomer units resulting from polymerization with monomers selected from the group consisting of maleic acid, monoalkyl maleate, dialkyl maleate, and/or maleic anhydride. In embodiments, the maleate monomer unit can be monomethyl maleate.

In embodiments, the maleate modified PVOH is substantially free of lactone rings, such that the modified PVOH has about 2 pendant carboxylate groups per maleate monomer unit. In embodiments, the maleate modified PVOH can comprise about 1.5 pendant carboxylate groups to 2 pendant carboxylate groups per maleate monomer unit, or about 1.2 pendant carboxylate groups to about 2 pendant carboxylate groups per maleate monomer unit, or about 1 pendant carboxylate groups to about 2 pendant carboxylate groups per maleate monomer unit, such as, about 2 pendant carboxylate groups per maleate monomer unit, or about 1.9 pendant carboxylate groups per maleate monomer unit, or about 1.8 pendant carboxylate groups per maleate monomer unit, or about 1.7 pendant carboxylate groups per maleate monomer unit, or about 1.6 pendant carboxylate groups per maleate monomer unit, or about 1.5 pendant carboxylate groups per maleate monomer unit, or about 1.2 pendant carboxylate groups per maleate monomer unit, or about 1 pendant carboxylate groups per maleate monomer unit.

In embodiments, the fiber forming material includes a sulfonate modified polyvinyl alcohol. In embodiments, the sulfonate modified PVOH is the only polyvinyl alcohol fiber forming material that the fiber is comprised of. In embodiments, the nonwoven web consists of fibers wherein the sulfonate modified PVOH is the only fiber forming material present. In embodiments, the fiber forming material includes sulfonate modified PVOH and a cellulose fiber forming material or a starch fiber forming material. In embodiments, the fiber forming material includes the sulfonate modified PVOH and polyvinylpyrrolidone, a carboxyl modified PVOH comprising a carboxylated anionic monomer unit, or both. In embodiments, the sulfonate modified PVOH comprises a sulfonated anionic monomer unit selected from the group consisting of vinyl sulfonic acid, allyl sulfonic acid, ethylene sulfonic acid, 2-acrylamido-1-methylpropanesulfonic acid, 2-acrylamido-2-methylpropanesulfonic acid (AMPS), 2-methylacrylamido-2-methylpropanesulfonic acid, 2-sulfoethyl acrylate, alkali salts thereof, and a combination thereof. In embodiments, the sulfonated anionic monomer unit is selected from the group consisting of 2-acrylamido-1-methylpropanesulfonic acid, 2-acrylamido-2-methylpropanesulfonic acid (AMPS), 2-methylacrylamido-2-methylpropanesulfonic acid, 2-sulfoethyl acrylate, alkali salts thereof, and a combination thereof. In embodiments, the sulfonated anionic monomer unit is selected from the group consisting of 2-acrylamido-2-methylpropanesulfonic acid (AMPS), 2-methylacrylamido-2-methylpropanesulfonic acid, alkali salts thereof, and a combination thereof. In embodiments, the sulfonated anionic monomer unit comprises AMPS. In embodiments, the sulfonate modified PVOH fiber forming material has a degree of hydrolysis of at least 95%. In embodiments, the sulfonate modified PVOH fiber forming material has a degree of hydrolysis in a range of 95% to 99.9%. In embodiments, the sulfonated anionic monomer unit is present in an amount in a range of about 1 mol % to about 5 mol %. In embodiments, the sulfonated anionic monomer unit is present in an amount in a range of about 1 mol % to about 3 mol %.

In general, the AMPS modified PVOH copolymer or the maleate modified PVOH copolymer, can be selected to provide one or more advantages. For example, the AMPS or maleate modified PVOH can provide improved resistance to harsh chemicals such as acids, oxidants, and bases that can cause damage to PVOH nonwovens. Without intending to be bound by theory, it is believed that the AMPS modifications can inhibit acid induced crosslinking of the PVOH, which can cause reduced solubility of the nonwoven in water and the AMPS modification and/or the maleate modification can inhibit acid/base induced polyene formation (condensation reactions) that can cause the nonwoven to yellow undesirably. Further, the AMPS and maleate modifications can provide one or more advantages to the resulting nonwoven, for example, reduced crystalline regions in the nonwoven resulting in reduced dissolution time.

When the fiber forming material comprises a PVOH copolymer including an anionic monomer unit, the level of incorporation of the one or more anionic monomer units in the PVOH copolymer is not particularly limited. In embodiments, the one or more anionic monomer units are present in the PVOH copolymer in an amount in a range of about 1 mol. % to about 10 mol. %, about 1.5 mol. % to about 8 mol. %, about 2 mol. % to about 6 mol. %, about 3 mol. % to about 5 mol. %, or about 1 mol. % to about 4 mol. % (e.g., at least about 1.0, 1.5, 1.8, 2.0, 2.5, 3.0, 3.5, or 4.0 mol. % and up to about 3.0, 4.0, 4.5, 5.0, 6.0, 8.0, or 10 mol. % in various embodiments). In embodiments, the anionic monomer comprises a maleate monomer unit and the maleate monomer unit is present in an amount in a range of about 1 mol % to 10 mol %, or about 1 mol % to 8 mol %, or about 1 mol % to 5 mol %. In embodiments, the anionic monomer comprises a maleate monomer unit and the maleate monomer unit is present in an amount in a range of about 1 mol % to 5 mol %. In embodiments, the anionic monomer comprises a sulfonated anionic monomer unit and the sulfonated anionic monomer unit is present an amount in a range of about 1 mol % to 10 mol %, or about 1 mol % to 8 mol %, or about 1 mol % to 5 mol %. In embodiments, the anionic monomer comprises a sulfonated anionic monomer unit and the sulfonated anionic monomer unit is present an amount in a range of about 1 mol % to 5 mol %.

Polyvinylpyrrolidone is a synthetic resin made from polymerizing the monomer N-vinylpyrrolidone. There have been many studies that have been devoted to the determination of the molecular weight of PVP polymer. The low molecular weight polymers have narrower distribution curves of molecular entities than the high molecular weight compounds. Some of the techniques for measuring the molecular weight of various PVP polymer products are based on measuring sedimentation, light scattering, osmometry, NMR spectroscopy, ebullimometry, and size exclusion chromatography for determining absolute molecular weight distribution. By the use of these methods, any one of three molecular weight parameters can be measured, namely the number average (Mn), viscosity average (Mv), and weight average (Mw). Each of these characteristics can yield a different answer for the same polymer. Therefore, in any review of the literature, one must know which molecular average is cited.

In embodiments, the polyvinylpyrrolidone can have a weight average molecular weight (M̅w) of at least about 3,000 g/mol. In various embodiments, the PVP can have a M̅w in a range of about 3,000 g/mol to about 10 million g/mol. In some embodiments, the PVP can have a M̅w in a range of about 30,000 g/mol to about 8 million g/mol, or about 60,000 g/mol to 5 million g/mol, or about 80,000 g/mol to about 5 million g/mol, or about 100.00 g/mol to about 5 million g/mol, or about 150,000 g/mol to about 4 million g/mol, or about 200,000 g/mol to about 4 million g/mol, or about 500,000 g/mol to about 4 million g/mol, or about 1 million g/mol to about 3 million g/mol. In embodiments, the PVP can have a M̅w of about 1.2 million g/mol to about 3 million. In various embodiments, the PVP can have a M̅w in a range of about 3,000 g/mol to about 5 million g/mol, such as about 3,000 g/mol, 5,000 g/mol, 10,000 g/mol, 30,000 g/mol, 50,000 g/mol, 100,000 g/mol, 200,000 g/mol, 500,000 g/mol, 1 million g/mol, 2 million g/mol, 3 million g/mol, 4 million g/mol or 5 million g/mol. The weight average molecular weight can be determined by those skilled in the art, for example, by methods such as size exclusion chromatography (gel permeation chromatography). When a PVP resin is described as having (or not having) a particular molecular weight, unless specified otherwise, it is intended that the specified molecular weight is the average molecular weight for the resin, which inherently has a corresponding molecular weight distribution.

Without intending to be bound by theory, it is believed that high Mw PVP polymers as disclosed herein are advantageous as they are resistant to migration out of the nonwoven when the nonwoven is in contact with dry and/or hygroscopic components. It is believed that the higher the Mw, the more entangled the individual polymer chains can become such that the PVP chains are less likely to separate from other components of the nonwoven and migrate out of the film.

The PVP polymer can provide a number of advantages when added as a fiber forming material to a fiber of the nonwoven web described herein. For example, without intending to be bound by theory, it is believed that the pyrrolidone functional groups of the PVP polymer can act as an acid trap and/or a pH buffer, reacting with H⁺ ions from the harsh chemicals (shown below in Scheme 1), thereby hindering acid induced cross-linking and discoloration of the polyvinyl alcohol. Further, PVOH homopolymer or copolymer nonwoven webs in contact with harsh chemicals typically become brittle over time, as the harsh chemicals draw out water and/or plasticizers from the nonwoven web. The harsh chemicals can be hygroscopic, which can result in the absorption other polar solvents and materials, such as commonly used as plasticizers. However, advantageously, the combination of the PVOH copolymer and the PVP in the fiber forming materials described herein can help prevent the nonwoven web from becoming brittle in the presence of harsh chemicals. The PVP in the nonwovens described herein can act similar to a plasticizer but is resistant to being drawn out of the nonwoven web by harsh chemicals. The PVP can also allow the nonwoven webs herein to maintain flexibility, even when the films include relatively low amounts of traditional plasticizer content and water content.

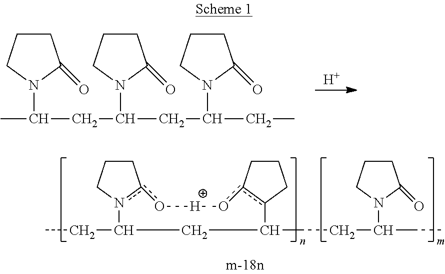

As described herein, the combination of sulfonate modified PVOH and carboxyl modified PVOH can advantageously provide resistance to degradation in the presence of harsh chemicals, such as acids, oxidants or bases.

As described herein, the sulfonate modified PVOH can advantageously provide resistance to degradation of the nonwoven in the presence of harsh chemicals, such as base-mediated oxidants. As used herein, the term “base-mediated oxidant” refers to an oxidant that oxidizes another chemical species using a basic mechanistic pathway to oxidation. A basic mechanistic pathway to oxidation refers a pathway wherein a base, such as ⁻OH, initiates or catalyzes the oxidation reaction of the reagent. For example, sodium hypochlorite, calcium hypochlorite, and monovalent and divalent salts having similar structures to sodium hypochlorite and calcium hypochlorite are considered base-mediated oxidants.

As described herein, the combination of PVOH and PVP can advantageously provide resistance to degradation in the presence of harsh chemicals, such as acids, oxidants or bases. For example, when PVOH is used as the sole resin, the harsh chemical can react with the PVOH to degrade the nonwoven web quickly. In contrast, it has been advantageously found that the combination of PVOH and PVP can stop or at least slow the degradation of the nonwoven web. Without intending to be bound by theory, it is believed that the pyrrolidone functional groups of the PVP can act as an acid trap, interacting with H⁺ ions from the harsh chemicals, preventing the H⁺ ions from promoting acid catalyzed elimination of the hydroxyl units of the vinyl alcohol, thereby hindering degradation of the polyvinyl alcohol. Conventional water soluble PVOH films have a tendency to degrade in the presence of harsh chemicals, such as chlorinated sanitizing agents and other oxidative chemicals, acids, and certain bases. Excessive oxidation causes the films to become insoluble in water, thus making them ineffective for unit-dose packaging agents. Without intending to be bound by theory, it is believed that the hypochlorite ions produced by certain harsh chemicals oxidize the pendant —OH moieties in the PVOH copolymer film, creating carbonyl groups on the polymer backbone. The carbonyl group is an intermediate step toward polyene formation (and yellowing) as it creates an acidic alpha hydrogen. The carbonyl group is also an intermediate to chain scission. Additionally, hydrochloric acid produced by certain harsh chemicals may react with the hydroxyl group to create unsaturated bonds in the polymer backbone which can cause decreased solubility in water as well as discoloration in the film. In either event, the removal of the pendant —OH groups makes the films increasingly insoluble in water.

Nonwoven webs including typical PVOH homopolymers or copolymers as the sole fiber forming materials in contact with harsh chemicals advantageously do not become brittle, as residual water migrates out of the nonwoven web in the presence of the harsh chemicals; however, such loss of water can result in shrinking of the fibers and, ultimately, the nonwoven web. Further advantageously, the sulfonate modified PVOH and/or the PVP can act similar to a rheology modifier for the carboxyl modified PVOH, allowing control over the flow of the fiber forming material during fiber production, as well as imparting chemical compatibility to the carboxyl modified PVOH in the presence of harsh chemicals by inhibiting the decomposition of the carboxyl modified PVOH by the harsh chemical.

The water soluble nonwoven web described herein can include the carboxyl modified PVOH fiber forming material and the sulfonate modified PVOH and/or polyvinylpyrrolidone fiber forming materials can be provided in a weight ratio of about 3:1 to about 19:1, respectively. In embodiments, the weight ratio of the carboxyl modified PVOH fiber forming material to the sulfonate modified PVOH and/or polyvinylpyrrolidone fiber forming materials is about 3:1 to about 18.2, about 3:1 to about 17:1, about 5:1 to about 15:1, about 5:1 to about 12:1, about 5:1 to about 9:1, about 6:1 to about 9:1, or about 6.5:1 to about 7.5:1 by weight, respectively. In embodiments, the weight ratio of the carboxyl modified PVOH fiber forming material to the sulfonate modified PVOH and/or polyvinylpyrrolidone fiber forming materials is about 5:1 to about 15:1, about 5:1 to about 12:1, about 5:1 to about 9:1, about 6:1 to about 9:1, about 6.5:1 to about 7.5:1, about 3:1 to about 6.5:1, or about 3:1 to about 5:1, by weight, respectively.

In embodiments, the water soluble nonwoven web disclosed herein can include a plurality of fibers comprising a blend of fiber forming materials comprising (i) polyvinylpyrrolidone, and (ii) a sulfonate modified PVOH, a carboxyl modified PVOH, or both. In embodiments, the weight ratio of the polyvinylpyrrolidone fiber forming materials to the sulfonate modified PVOH fiber forming materials, the carboxyl modified PVOH fiber forming materials, or both is about 1:1 to about 1:19 by weight, respectively. In embodiments, the weight ratio of the polyvinylpyrrolidone fiber forming materials to the sulfonate modified PVOH fiber forming materials, the carboxyl modified PVOH fiber forming materials, or both is about 1:3 to about 1:19, about 1:5 to about 1:15 by weight, about 1:5 to about 1:12 by weight, about 1:5 to about 1:9 by weight, about 1:6 to about 1:9 by weight, or about 1:6.5 to about 1:7.5 by weight, respectively.

Water Soluble Nonwoven Web

The water soluble nonwoven web of the disclosure generally includes a plurality of water soluble fibers. A nonwoven web generally refers to an arrangement of fibers bonded to one another, wherein the fibers are neither woven nor knitted. In general, the plurality of water soluble fibers can be arranged in any orientation. In embodiments, the plurality of water soluble fibers are arranged randomly (i.e., do not have an orientation). In embodiments, the plurality of water soluble fibers are arranged in a unidirectional orientation. In embodiments, the plurality of water soluble fibers are arranged in a bidirectional orientation. In some embodiments, the plurality of water soluble fibers are multi-directional, having different arrangements in different areas of the nonwoven web.

In general, the plurality of fibers in any given nonwoven web can include any fiber forming materials disclosed herein. The nonwoven web can include (1) a single fiber type including a single fiber forming material, (2) a single fiber type including a blend of fiber forming materials, (3) a blend of fiber types, each fiber type including a single fiber forming material, (4) a blend of fiber types, each fiber type including a blend of fiber forming materials, or (5) a blend of fiber types, each fiber type including a single fiber forming material or a blend of fiber forming materials. In embodiments including a blend of fiber types, the different fiber types can have a difference in diameter, length, tenacity, shape, rigidness, elasticity, solubility, melting point, glass transition temperature (T_{g}), fiber forming material chemistries, color, or a combination thereof.

In embodiments, the plurality of water soluble fibers include polyvinyl alcohol polymer. In a refinement of the foregoing embodiment, the water soluble fiber includes a PVOH copolymer. In embodiments, the water soluble fiber includes a single PVOH copolymer resin. In embodiments, the water soluble fiber includes a blend of fiber forming materials including a blend of polyvinyl alcohol polymers. In embodiments, the water soluble fiber includes a blend of fiber forming materials including a blend of a polyvinyl alcohol polymer and a PVP polymer. In embodiments, the water soluble polymer includes two or more PVOH copolymers and a PVP polymer.

In embodiments, the nonwoven web can include a plurality of fibers including a sulfonate modified PVOH fiber forming material comprising a sulfonated anionic monomer unit. In embodiments, the sulfonate modified PVOH fiber forming material has a degree of hydrolysis of at least 95%. In embodiments, the sulfonated anionic monomer is present in an amount in a range of about 1 mol % to about 5 mol %.

In embodiments, a nonwoven web or unit dose as described herein that includes fibers including a sulfonate modified PVOH, such as AMPS modified PVOH, that has a degree of hydrolysis of at least 95% and the sulfonated anionic monomer is present in an amount in a range of about 1 mol % to about 5 mol % can provide one or more advantages. For example, improved resistance to harsh chemical such base-mediated oxidants that cause degradation to the nonwoven web. Further, the sulfonate modified PVOH fiber forming material can provide a nonwoven web having good long term storage properties (e.g., maintained solubility properties and resistance to discoloration) as determined by exposing the web to a base-mediated oxidant composition, such as calcium hypochlorite, for 6 weeks in a 38° C. and 80% RH atmosphere. Such webs can demonstrate a disintegration time of no more than 300 seconds according to MSTM 205 in 23° C. water, and/or maintain a b* value of no more than 3.5, or no more than 3.0. The 38° C. and 80% RH atmosphere can be maintained by packaging the water soluble nonwoven webs in contact with the base-mediated oxidant in a secondary packaging prepared from a 4 mil high density polyethylene (HDPE) film.

In embodiments, the nonwoven web can include a plurality of fibers comprising a blend of fiber forming materials comprising (i) polyvinylpyrrolidone, and (ii) a sulfonate modified PVOH, a carboxyl modified PVOH, or both. In embodiments, the blend of fiber forming materials can include polyvinylpyrrolidone and a sulfonate modified PVOH. In embodiments, the blend of fiber forming materials can include polyvinylpyrrolidone and a carboxyl modified PVOH. In embodiments, the blend of fiber forming materials can include polyvinylpyrrolidone, a sulfonate modified PVOH, and a carboxyl modified PVOH.

In embodiments, a nonwoven web or unit dose as described herein that includes fibers including a combination polyvinylpyrrolidone and a carboxyl modified PVOH fiber forming material, a sulfonate modified PVOH, or both can provide one or more advantages. For example, improved resistance to harsh chemical such as acids, oxidants, and bases that cause damage to the nonwoven web. Further, the combination can provide a nonwoven web having good long term storage properties (e.g., maintaining solubility properties and resistance to discoloration) as determined by exposing the web to a trichloroisocyanuric acid (TCCA) or sodium bisulfate (SBS) composition for 8 weeks in a 38° C. and 80% RH atmosphere. Such webs can demonstrate a disintegration time of no more than 300 seconds according to MSTM 205 in 23° C. water, leave no more than 50% nonwoven web residue, based on the surface area of the starting nonwoven web and the nonwoven web after testing according to MSTM 205 in 23° C. water, and/or maintain a b* value of no more than 3.5. TCCA is considered one of the harshest oxidants in the art and is, therefore, considered a good proxy for all harsh chemicals. The 38° C. and 80% RH atmosphere can be maintained by packaging the water soluble nonwoven webs in contact with the harsh chemicals in a secondary packaging prepared from a 4 mil high density polyethylene (HDPE) film.

In embodiments, the water soluble nonwoven web can include a plurality of fibers including:

(a) a blend of fiber forming materials including (i) a carboxyl modified PVOH and (ii) a and (ii) sulfonate modified PVOH, PVP, or both;
(b) a blend of fibers including (iii) a fiber comprising a carboxyl modified PVOH fiber forming material and (iv) a fiber comprising a sulfonate modified PVOH fiber forming material, a fiber comprising a PVP fiber forming material, or both types of fiber; or
(c) a blend of fibers including (v) a first fiber comprising a carboxyl modified PVOH fiber forming material, a sulfonate modified PVOH fiber forming material, or a PVP fiber forming material and (vi) a second fiber comprising a blend of fiber forming materials comprising a carboxyl modified PVOH fiber forming material, a sulfonate modified PVOH fiber forming material, a PVP fiber forming material or a combination thereof,
wherein in any of (a), (b), and (c), the weight ratio of the carboxyl modified PVOH fiber forming material to the sulfonate modified PVOH and/or PVP fiber forming materials is about 3:1 to about 19:1 by weight, respectively.

In embodiments, the blend of fiber forming materials, (a), can include (i) a maleate modified PVOH fiber forming material and (ii) a sulfonate modified PVOH fiber forming material. In embodiments, the blend of fiber forming materials, (a), can include (i) a maleate modified PVOH fiber forming material and (ii) a PVP fiber forming material. In embodiments, the blend of fiber forming materials, (a), can include (i) a maleate modified PVOH fiber forming material and (ii) a sulfonate modified PVOH fiber forming material and a PVP fiber forming material. In embodiments, the blend of fiber forming materials, (a), can include (ii) a PVP fiber forming material. In refinements of the foregoing embodiments, the sulfonate modified PVOH fiber forming material comprises AMPS.

In embodiments, the blend of fibers (b) can include (iii) a fiber comprising a maleate modified PVOH fiber forming material and (iv) a fiber comprising a sulfonate modified PVOH fiber forming material. In embodiments, the blend of fibers (b) can include (iii) a fiber comprising a maleate modified PVOH fiber forming material and (iv) a fiber comprising a PVP fiber forming material, in embodiments, the blend of fibers (b) can include (iii) a fiber comprising a maleate modified PVOH fiber forming material and (iv) a fiber comprising a sulfonate modified PVOH fiber forming material and a fiber comprising a PVP fiber forming material. In embodiments, the blend of fibers (b) can include (iv) a fiber comprising a PVP fiber forming material. In refinements of the foregoing embodiments, the sulfonate modified PVOH fiber forming material comprises AMPS.

In embodiments, the a blend of fibers (c) can include (v) a first fiber comprising a carboxyl modified PVOH fiber forming material and (vi) a second fiber comprising a blend of fiber forming materials comprising a carboxyl modified PVOH fiber forming material and a sulfonate modified PVOH fiber forming material. In embodiments, the a blend of fibers (c) can include (v) a first fiber comprising a carboxyl modified PVOH fiber forming material and (vi) a second fiber comprising a blend of fiber forming materials comprising a carboxyl modified PVOH fiber forming material and a PVP fiber forming material. In embodiments, the a blend of fibers (c) can include (v) a first fiber comprising a carboxyl modified PVOH fiber forming material and (vi) a second fiber comprising a blend of fiber forming materials comprising a carboxyl modified PVOH fiber forming material, a sulfonate modified PVOH fiber forming material, and a PVP fiber forming material. In embodiments, the blend of fibers (c) can include (vi) a second fiber comprising a PVP fiber forming material. In refinements of the foregoing embodiments, the carboxyl modified PVOH comprises a maleate modified PVOH and the sulfonate modified PVOH fiber forming material comprises AMPS.

In embodiments, the a blend of fibers (c) can include (v) a first fiber comprising a sulfonate modified PVOH fiber forming material and (vi) a second fiber comprising a blend of fiber forming materials comprising a carboxyl modified PVOH fiber forming material and a sulfonate modified PVOH fiber forming material. In embodiments, the a blend of fibers (c) can include (v) a first fiber comprising a sulfonate modified PVOH fiber forming material and (vi) a second fiber comprising a blend of fiber forming materials comprising a carboxyl modified PVOH fiber forming material and a PVP fiber forming material or a combination thereof. In embodiments, the a blend of fibers (c) can include (v) a first fiber comprising a sulfonate modified PVOH fiber forming material and (vi) a second fiber comprising a blend of fiber forming materials comprising a carboxyl modified PVOH fiber forming material, a sulfonate modified PVOH fiber forming material, and a PVP fiber forming material. In refinements of the foregoing embodiments, the carboxyl modified PVOH comprises a maleate modified PVOH and the sulfonate modified PVOH fiber forming material comprises AMPS.

In embodiments, the a blend of fibers (c) can include (v) a first fiber comprising a PVP fiber forming material and (vi) a second fiber comprising a blend of fiber forming materials comprising a carboxyl modified PVOH fiber forming material and a sulfonate modified PVOH fiber forming material. In embodiments, the a blend of fibers (c) can include (v) a first fiber comprising a PVP fiber forming material and (vi) a second fiber comprising a blend of fiber forming materials comprising a carboxyl modified PVOH fiber forming material and a PVP fiber forming material. In embodiments, the a blend of fibers (c) can include (v) a first fiber comprising a PVP fiber forming material and (vi) a second fiber comprising a blend of fiber forming materials comprising a carboxyl modified PVOH fiber forming material, a sulfonate modified PVOH fiber forming material, and a PVP fiber forming material. In refinements of the foregoing embodiments, the carboxyl modified PVOH comprises a maleate modified PVOH and the sulfonate modified PVOH fiber forming material comprises AMPS.

In embodiments, a water soluble nonwoven web as described herein that includes a sulfonate modified PVOH fiber forming material, such as AMPS modified PVOH, or a carboxyl modified PVOH fiber forming material, such as a maleate modified PVOH, or PVP fiber forming material can be selected to provide one or more advantages. In embodiments, a blend of fibers and/or fiber forming materials comprising the maleate modified PVOH and, the AMPS modified PVOH, the PVP or a combination thereof, can offer improved resistance to harsh chemicals such as acids, oxidants, and bases that cause damage to the water soluble nonwoven.

In embodiments, a water soluble nonwoven web or unit dose as described herein that includes fibers including a combination of carboxyl modified PVOH fiber forming material and sulfonate modified PVOH and/or PVP fiber forming materials can provide one or more advantages. For example, improved resistance to harsh chemical such as acids, oxidants, and bases that cause damage to the water soluble film. Further, the combination can provide a water soluble web having good long term storage properties as determined by exposing the web to a trichloroisocyanuric acid (TCCA) or sodium bisulfate (SBS) composition for 8 weeks in a 38° C. and 80% RH atmosphere. Such webs can demonstrate a disintegration time of no more than 300 seconds according to MSTM 205 in 23° C. water, leave no more than 50% nonwoven web residue, based on the surface area of the starting nonwoven web and the nonwoven web after testing according to MSTM 205 in 23° C. water, maintain an average elongation of at least 90%, and/or maintain a b* value of no more than 3.5. TCCA is considered one of the harshest oxidants in the art and is, therefore, a good proxy for all harsh chemicals. The 38° C. and 80% RH atmosphere was maintained by packaging the water soluble nonwoven webs in contact with the harsh chemicals in a secondary packaging prepared from a 4 mil high density polyethylene (HDPE) film.

The nonwoven webs can further include fibers comprising a fiber forming material comprising one or more water soluble polymers including, but not limited to, polyvinyl alcohols (e.g., a carboxyl modified PVOH comprising a carboxylated anioinic monomer unit), polyvinylpyrrolidone, water soluble acrylate copolymers, polyethyleneimine, pullulan, water soluble natural polymers including, but not limited to, guar gum, gum Acacia, xanthan gum, carrageenan, and starch, water soluble polymer modified starches, copolymers of the foregoing or a combination of any of the foregoing. Yet other water soluble polymers can include polyalkylene oxides, polyacrylamides, celluloses, cellulose ethers, cellulose esters, cellulose amides, polyvinyl acetates, polycarboxylic acids and salts thereof, polyaminoacids, polyamides, gelatines, methylcelluloses, carboxymethylcelluloses and salts thereof, dextrins, ethylcelluloses, hydroxyethyl celluloses, hydroxypropyl methylcelluloses, maltodextrins, polymethacrylates, or a combination of any of the foregoing. Such water soluble polymers are commercially available from a variety of sources. In one type of embodiment, the type and/or amount of additional polymer(s) will not result in the water soluble nonwoven web having less resistance to the harsh chemical. In embodiments, (a) the plurality of plurality of fibers further comprises a fiber comprising, cellulose, starch, a carboxyl modified PVOH comprising a carboxylated anionic monomer unit, or a combination thereof; (b) the plurality of fibers comprising the sulfonate modified PVOH fiber forming material further comprises a fiber forming material comprising cellulose, starch, polyvinylpyrrolidone, a carboxyl modified PVOH comprising a carboxylated anionic monomer unit, or a combination thereof; or (c) a combination of (a) and (b). In embodiments, the plurality of fibers can further comprise a fiber comprising cellulose, starch, a carboxyl modified PVOH comprising a carboxylated anionic monomer unit, or a combination thereof. In embodiments, the plurality of fibers can comprise a fiber comprising a blend of fiber forming materials comprising a sulfonate modified PVOH fiber forming material and cellulose, starch, polyvinylpyrrolidone, a carboxyl modified PVOH comprising a carboxylated anionic monomer unit, or a combination thereof. In embodiments, the cellulose can comprise cellulose, carboxymethyl cellulose (CMC), hydroxymethyl cellulose (HMC), hydropropylmethyl cellulose (HPMC), hydroxyethyl cellulose (HEC), hydroxypropyl cellulose (HPC), methyl cellulose, ethyl cellulose, ethyl methyl cellulose, salts of the foregoing, or combinations of the foregoing. In embodiments, the cellulose can comprise sodium carboxymethyl cellulose (CMC). In embodiments, the CMC can have about 20% to about 60% substitution.

The water soluble fibers and/or water soluble nonwoven webs can include other auxiliary agents and processing agents, such as, but not limited to, plasticizers, plasticizer compatibilizers, surfactants, colorants, acid scavengers, lubricants, release agents, fillers, extenders, cross-linking agents, antiblocking agents, antioxidants, detackifying agents, antifoams, nanoparticles such as layered silicate-type nanoclays (e.g., sodium montmorillonite), bleaching agents (e.g., sodium metabisulfite, sodium bisulfate or others), aversive agents such as bitterants (e.g., denatonium salts such as denatonium benzoate, denatonium saccharide, and denatonium chloride; sucrose octaacetate; quinine; flavonoids such as quercetin and naringen; and quassinoids such as quassin and brucine) and pungents (e.g., capsaicin, piperine, allyl isothiocyanate, and resinferatoxin), cellulose, starch, and other functional ingredients, in amounts suitable for their intended purposes. Specific such auxiliary agents and processing agents can be selected from those suitable for use in water soluble fibers, or those suitable for use in water soluble nonwoven webs.

In embodiments, the water soluble fiber and/or nonwoven web includes cellulose, starch, or a combination thereof. In embodiments, the water soluble fiber and/or nonwoven web includes cellulose. In embodiments, the water soluble fiber and/or nonwoven web includes starch.

In embodiments, the water soluble fibers and water soluble nonwoven webs are free of auxiliary agents. As used herein and unless specified otherwise, “free of auxiliary agents” with respect to the fiber means that the fiber includes less than about 0.01 wt %, less than about 0.005 wt. %, or less than about 0.001 wt. % of auxiliary agents, based on the total weight of the fiber. As used herein and unless specified otherwise, “free of auxiliary agents” with respect to the nonwoven web means that the nonwoven web includes less than about 0.01 wt %, less than about 0.005 wt. %, or less than about 0.001 wt. % of auxiliary agents, based on the total weight of the nonwoven web. In embodiments, the water soluble fibers comprise a plasticizer. In embodiments, the water soluble fibers comprise a surfactant. In embodiments, the nonwoven web includes a plasticizer. In embodiments, the nonwoven web includes a surfactant. In embodiments, the water soluble fibers are free of auxiliary agents other than plasticizers, surfactants, cellulose, starch, or combinations thereof. In embodiments, the water soluble nonwoven webs are free of auxiliary agents other than plasticizers, surfactants, cellulose, starch, or combinations thereof.

A plasticizer is a liquid, solid, or semi-solid that is added to a material (usually a resin or elastomer) making that material softer, more flexible (by decreasing the glass-transition temperature of the polymer), and easier to process. A polymer can alternatively be internally plasticized by chemically modifying the polymer or monomer. In addition or in the alternative, a polymer can be externally plasticized by the addition of a suitable plasticizing agent. Water is recognized as a very efficient plasticizer for PVOH and other polymers; including but not limited to water soluble polymers, however, the volatility of water makes its utility limited since polymer nonwoven webs need to have at least some resistance (robustness) to a variety of ambient conditions including low and high relative humidity.

The plasticizer can include, but is not limited to, glycerin, diglycerin, sorbitol, ethylene glycol, diethylene glycol, triethylene glycol, dipropylene glycol, tetraethylene glycol, propylene glycol, polyethylene glycols up to 400 MW, neopentyl glycol, trimethylolpropane, polyether polyols, 2-methyl-1,3-propanediol (MPDiol®), ethanolamines, maltitol, and a mixture thereof. In embodiments, the plasticizer is selected from the group consisting of glycerol, maltitol, trimethylolpropane, or a combination thereof. The total amount of the non-water plasticizer provided in a fiber can be in a range of about 1 wt. % to about 45 wt. %, or about 5 wt. % to about 45 wt. %, or about 10 wt. % to about 40 wt. %, or about 20 wt. % to about 30 wt. %, about 1 wt. % to about 4 wt. %, or about 1.5 wt. % to about 3.5 wt. %, or about 2.0 wt. % to about 3.0 wt. %, for example about 1 wt. %, about 2.5 wt. %, about 5 wt. %, about 10 wt. %, about 15 wt. %, about 20 wt. %, about 25 wt. %, about 30 wt. %, about 35 wt. %, or about 40 wt. %, based on total fiber weight.

Surfactants for use in fibers are well known in the art. Optionally, surfactants are included to aid in the dispersion of the fibers during carding. Suitable surfactants for fibers of the present disclosure include, but are not limited to, dialkyl sulfosuccinates, lactylated fatty acid esters of glycerol and propylene glycol, lactylic esters of fatty acids, sodium alkyl sulfates, polysorbate 20, polysorbate 60, polysorbate 65, polysorbate 80, alkyl polyethylene glycol ethers, lecithin, acetylated fatty acid esters of glycerol and propylene glycol, sodium lauryl sulfate, acetylated esters of fatty acids, myristyl dimethyl amine oxide, trimethyl tallow alkyl ammonium chloride, quaternary ammonium compounds, quaternary amines, alkali metal salts of higher fatty acids containing about 8 to 24 carbon atoms, alkyl polyethylene glycol ethers, alkyl sulfates, alkyl polyethoxylate sulfates, alkylbenzene sulfonates, monoethanolamine, lauryl alcohol ethoxylate, propylene glycol, diethylene glycol, cocamides, salts thereof and combinations of any of the forgoing. In embodiments, the surfactant comprises quaternary amines, myristyl dimethyl amine oxide, alkyl polyethylene glycol ether, cocamides, or a combination thereof.

Suitable surfactants can include the nonionic, cationic, anionic and zwitterionic classes. Suitable surfactants include, but are not limited to, propylene glycols, diethylene glycols, monoethanolamine, polyoxyethylenated polyoxypropylene glycols, alcohol ethoxylates, alkylphenol ethoxylates, tertiary acetylenic glycols and alkanolamides (nonionics), polyoxyethylenated amines, quaternary ammonium salts and quaternized polyoxyethylenated amines (cationics), alkali metal salts of higher fatty acids containing about 8 to 24 carbon atoms, alkyl sulfates, alkyl polyethoxylate sulfates and alkylbenzene sulfonates (anionics), and amine oxides, N-alkylbetaines and sulfobetaines (zwitterionics). Other suitable surfactants include dioctyl sodium sulfosuccinate, lactylated fatty acid esters of glycerin and propylene glycol, lactylic esters of fatty acids, sodium alkyl sulfates, polysorbate 20, polysorbate 60, polysorbate 65, polysorbate 80, lecithin, acetylated fatty acid esters of glycerin and propylene glycol, and acetylated esters of fatty acids, and combinations thereof. In various embodiments, the amount of surfactant in the fiber is in a range of about 0.01 wt. %, to about 2.5 wt. %, about 0.1 wt. % to about 2.5 wt. %, about 1.0 wt. % to about 2.0 wt. %, about 0.01 wt % to 0.25 wt %, or about 0.10 wt % to 0.20 wt %.

In particular embodiments, the surfactant used in the water soluble films can be a quaternary ammonium surfactant or other surfactant that is basic and includes hindered amine character, and can advantageously provide antioxidant protection from the harsh chemical. For example, myristyl (C₁₄) dimethylamine oxide, dioctyldimethyl ammonium chloride salts, or a combination thereof can provide the film with advantageous antioxidant protection.

In embodiments, the water soluble nonwoven webs herein can further include one or more acid scavenger and/or antioxidant. The acid scavengers and/or antioxidants are believed to reduce damaging effects of the composition on the water soluble nonwoven web, such as reducing the degradation of the water soluble nonwoven web, or reducing the yellowing of the water soluble nonwoven web, or maintaining the tensile strength of the water soluble nonwoven web. Further without intending to be bound by theory it is believed that the inclusion of an acid scavenger or antioxidant would mitigate acid catalyzed hydrolysis and condensation reactions and help reduce the amount of acid in the nonwoven web environment which can promote the oxidative activity of hypochlorite in the form of hypochlorous acid.

In embodiments, the acid scavenger can comprise one or more of N-vinyl pyrrolidone, sodium metabisulfite, activated olefins, maleate molecules (e.g., maleic acid and its derivatives), allylic compounds (e.g., allylic alcohols, allylic acetates, etc.), ethylene containing compounds, quaternary ammonium compounds, amines (e.g., pyridine, monoethanolamine, methylamine, aniline) and tertiary amine containing compounds. The acid scavenger can be included in the films described herein in an amount in a range of about 0.25 PHR to about 15 PHR, for example, about 0.25 PHR, about 1 PHR, about 1.5 PHR, about 2 PHR, about 3 PHR, about 4 PHR, about 5 PHR, about 5.5 PHR, about 6 PHR, about 6.5 PHR, about 7 PHR, about 8 PHR, about 9 PHR, about 10 PHR, or about 15 PHR.

In embodiments, the acid scavenger can be provided in or on the fiber, in or on the nonwoven web, or in or on both. In embodiments, the acid scavenger can be coated on the fiber, coated on the nonwoven web, or both. In embodiments, the acid scavenger can be dispersed throughout the nonwoven web. The acid scavenger can be adsorbed to the fibers throughout the nonwoven web or bound by static forces. For example, the acid scavenger can be added as the fibers are being laid down such that the acid scavenger is provided throughout the nonwoven web. In embodiments, the acid scavenger can be provided in the fiber forming material during processing, such that the acid scavenger is provided in the fiber itself.

In embodiments, the water soluble nonwoven web can further include an antioxidant, for example, a chloride scavenger. For example, suitable antioxidants/chloride scavengers include sulfite, bisulfite, thiosulfate, thiosulfate, iodide, nitrite, carbamate, ascorbate, and combinations thereof. In embodiments, the antioxidantis selected from propyl gallate (PGA), gallic acid, citric acid (CA), sodium metabisulfite (SMBS), carbamate, ascorbate, and combinations thereof. In embodiments, the antioxidant is selected from the group consisting of sodium metabisulfite, propyl gallate, gallic acid, phenolic compounds, hindered amines, citric acid, zinc acetate, and combinations thereof. In embodiments, the antioxidant can be selected from the group consisting of propyl gallate, gallic acid, phenolic compounds, hindered amines, sodium metabisulfite, zinc acetate, and a combination thereof. The antioxidant can be included in the nonwoven web in an amount in a range of about 0.25 to about 10 PHR, for example, about 0.25 PHR, about 1 PHR, about 1.5 PHR, about 2 PHR, about 3 PHR, about 4 PHR, about 5 PHR, about 5.5 PHR, about 6 PHR, about 6.5 PHR, about 7 PHR, about 8 PHR, about 9 PHR, or about 10 PHR. In embodiments, the antioxidant can be included in the nonwoven web in an amount in a range of about 2 to about 7 PHR.

In embodiments, the antioxidant can be provided in or on the fiber, in or on the nonwoven web, or in or on both. In embodiments, the antioxidant can be coated on the fiber, coated on the nonwoven web, or both. In embodiments, the antioxidant can be dispersed throughout the nonwoven web. The antioxidant can be adsorbed to the fibers throughout the nonwoven web or bound by static forces For example, the antioxidant can be added as the fibers are being laid down such that the acid scavenger is provided throughout the nonwoven web. In embodiments, the antioxidant can be provided in the fiber forming material during processing, such that the acid scavenger is provided in the fiber itself.

In embodiments, the water soluble nonwoven web can further include a filler, for example, a filler selected from the group consisting of high amylose starch, amorphous silica, hydroxyethylated starch, and a combination thereof. The filler can be provided in or on the fiber, in or on the nonwoven web, or in or on both as described herein for acid scavengers and antioxidants. In embodiments, the filler can be coated on the fiber, coated on the nonwoven web, or both. In embodiments, the filler can be dispersed throughout the nonwoven web. The filler can be adsorbed to the fibers throughout the nonwoven web or bound by static forces In embodiments, the filler can be provided in the fiber forming material.

The plurality of water soluble fibers can be prepared by any process known in the art, for example, wet cool gel spinning, thermoplastic fiber spinning, melt blowing, spun bonding, electro-spinning, rotary spinning, continuous filament producing operations, tow fiber producing operations, and combinations thereof. In embodiments, the fibers comprise water soluble fibers prepared by wet cool gel spinning, melt blowing, spun bonding, or a combination thereof. In embodiments, the fibers comprise water soluble fibers that are prepared by wet cool gel spinning, and are carded into nonwoven webs.

It is standard in the art to refer to fibers and nonwoven webs by the process used to prepare the same. Thus, any reference herein to, for example, a “melt blown fiber” or a “carded nonwoven web” should not be understood to be a product-by-process limitation for a particular melt blown or carding method, but rather merely identifying a particular fiber or web. Processing terms may therefore be used to distinguish fibers and/or nonwovens, without limiting the recited fiber and/or nonwoven to preparation by any specific process.

The fibers of the disclosure can be bicomponent fibers. As used herein, and unless specified otherwise, “bicomponent fibers” do not refer to a fiber including a blend of fiber forming materials but, rather, refer to fibers including two or more distinct regions of fiber forming materials, wherein the composition of the fiber forming materials differ by region. Examples of bicomponent fibers include, but are not limited to, core/sheath bicomponent fibers, island in the sea bicomponent fibers, and side-by-side bicomponent fibers. Core/sheath bicomponent fibers generally include a core having a first composition of fiber forming materials (e.g., a single fiber forming material or a first blend of fiber forming materials) and a sheath having a second composition of fiber forming materials (e.g., a single fiber forming material that is different from the core material, or a second blend of fiber forming materials that is different from the first blend of fiber forming materials of the core). Island in the sea bicomponent fibers generally include a first, continuous, “sea” region having a first composition of fiber forming materials and discreet “island” regions dispersed therein having a second composition of fiber forming materials that is different from the first composition. Side-by-side bicomponent fibers generally include a first region running the length of the fiber and including a first composition of fiber forming materials adjacent to at least a second region running the length of the fiber and including second composition of fiber forming materials that is different from the first composition. Such bicomponent fibers are well known in the art.

The shape of the fiber is not particularly limited and can have cross-sectional shapes including, but is not limited to, round, oval (also referred to as ribbon), triangular (also referred to as delta), trilobal, and/or other multi-lobal shapes (FIG. 1). It will be understood that the shape of the fiber need not be perfectly geometric, for example, a fiber having a round cross-sectional shape need not have a perfect circle as the cross-sectional area, and a fiber having a triangular cross-sectional shape generally has rounded corners. Without intending to be bound by theory, it is believed that hygroscopic fibers in a nonwoven that have a shape providing a capillary or channel type directional passage for a liquid (e.g., a trilobal fiber) can facilitate capillary action/wicking of a liquid from a surface of the nonwoven, providing improved liquid acquisition relative to an identical nonwoven having a fiber shape that does not include a capillary or channel type direction passage.

It will be understood that the diameter of a fiber refers to the cross-section diameter of the fiber along the longest cross-sectional axis. When a fiber is described as having (or not having) a particular diameter, unless specified otherwise, it is intended that the specified diameter is the average diameter for the specific fiber type referenced, i.e., a plurality of fibers prepared from polyvinyl alcohol fiber forming material has an arithmetic average fiber diameter over the plurality of fibers. For shapes not typically considered to have a “diameter”, e.g., a triangle or a multi-lobal shape, the diameter refers to the diameter of a circle circumscribing the fiber shape (FIG. 1).

The fibers of the disclosure typically have a diameter in a range of about 10 micron to 300 micron, for example, at least 10 micron, at least 15 micron, at least 20 micron, at least 25 micron, at least 50 micron, at least 100 micron, or at least 125 micron and up to about 300 micron, up to about 275 micron, up to about 250 micron, up to about 225 micron, up to about 200 micron, up to about 100 micron, up to about 50 micron, up to about 45 micron, up to about 40 micron, or up to about 35 micron, for example, in a range of about 10 micron to about 300 micron, about 50 micron to about 300 micron, about 100 micron to about 300 micron, about 10 micron to about 50 micron, about 10 micron to about 45 micron, or about 10 micron to about 40 micron. In embodiments, the water soluble fibers used to prepare the water-dispersible nonwoven webs of the disclosure can have a diameter greater than 100 micron to about 300 micron. In embodiments, the fibers comprise cellulose having a diameter in a range of about 10 micron to about 50 micron, about 10 micron to about 30 micron, about 10 micron to about 25 micron, about 10 micron to about 20 micron, or about 10 micron to about 15 micron. In embodiments, the fibers comprise a water soluble fiber forming material and have a diameter of about 50 micron to about 300 micron, about 100 micron to about 300 micron, about 150 micron to about 300 micron, or about 200 micron to about 300 micron. In embodiments, the diameters of the plurality of the water soluble fibers used to prepare the water-dispersible nonwoven webs of the disclosure have diameters that are substantially uniform. As used herein, fiber diameters are “substantially uniform” if the variance in diameter between fibers is less than 10%, for example 8% or less, 5% or less, 2% or less, or 1% or less. Fibers having substantially uniform diameters can be prepared by a wet cooled gel spinning process or a thermoplastic fiber spinning, as described herein. Further, when a blend of fibers is used, the average diameter of the fibers can be determined using a weighted average of the individual fibers.

The fibers of the disclosure used to prepare the nonwoven webs and nonwoven composite articles of the disclosure can generally be of any length. In embodiments, the length of the fibers can be in a range of about 20 mm to about 100 mm, about 20 to about 90, about 30 mm to about 80 mm, about 10 mm to about 60 mm, or about 30 mm to about 60 mm, for example, at least about 30 mm, at least about 35 mm, at least about 40 mm, at least about 45 mm, or at least about 50 mm, and up to about 100 mm, up to about 95 mm, up to about 90 mm, up to about 80 mm, up to about 70 mm, or up to about 60 mm. In embodiments, the length of the water soluble fibers can be less than about 30 mm or in a range of about 0.25 mm to less than about 30 mm, for example, at least about 0.25 mm, at least about 0.5 mm, at least about 0.75 mm, at least about 1 mm, at least about 2.5 mm, at least about 5 mm, at least about 7.5 mm, or at least about 10 mm and up to about 29 mm, up to about 28 mm, up to about 27 mm, up to about 26 mm, up to about 25 mm, up to about 20 mm, or up to about 15 mm. The fibers can be prepared to any length by cutting and/or crimping an extruded polymer mixture. In embodiments, the fiber can be a continuous filament, for example, prepared by processes such as spun bonding, melt blowing, electro-spinning, and rotary spinning wherein a continuous filament is prepared and provided directly into a web form. Further, when a blend of fibers is used, the average length of the fibers can be determined using a weighted average of the individual fibers.

The fibers of the disclosure can generally have any length to diameter ratio. In embodiments, length to diameter ratio of the fibers can be greater than about 2, greater than about 3, greater than about 4, greater than about 6, greater than about 10, greater than about 50, greater than about 60, greater than about 100, greater than about 200, greater than about 300, greater than about 400, or greater than about 1000.

The water soluble fibers used to prepare the water soluble nonwoven webs of the disclosure can generally have any tenacity. The tenacity of the fiber correlates to the coarseness of the fiber. As the tenacity of the fiber decreases the coarseness of the fiber increases. Fibers used to prepare the water soluble nonwoven webs of the disclosure can have a tenacity in a range of about 1 to about 100 cN/dtex, or about 1 to about 75 cN/dtex, or about 1 to about 50 cN/dtex, or about 1 to about 45 cN/dtex, or about 1 to about 40 cN/dtex, or about 1 to about 35 cN/dtex, or about 1 to about 30 cN/dtex, or about 1 to about 25 cN/dtex, or about 1 to about 20 cN/dtex, or about 1 to about 15 cN/dtex, or about 1 to about 10 cN/dtex, or about 3 to about 8 cN/dtex, or about 4 to about 8 cN/dtex, or about 6 to about 8 cN/dtex, or about 4 to about 7 cN/dtex, or about 10 to about 20, or about 10 to about 18, or about 10 to about 16, or about 1 cN/dtex, about 2 cN/dtex, about 3 cN/dtex, about 4 cN/dtex, about 5 cN/dtex, about 6 cN/dtex, about 7 cN/dtex, about 8 cN/dtex, about 9 cN/dtex, about 10 cN/dtex, about 11 cN/dtex, about 12 cN/dtex, about 13 cN/dtex, about 14 cN/dtex, or about 15 cN/dtex. In embodiments, the fibers can have a tenacity of about 3 cN/dtex to about 10 cN/dtex. In embodiments, the fibers can have a tenacity of about 5 cN/dtex to about 10 cN/dtex. In embodiments, the fibers can have a tenacity of about 7 cN/dtex to about 10 cN/dtex. In embodiments, the fibers can have a tenacity of about 4 cN/dtex to about 8 cN/dtex. In embodiments, the fibers can have a tenacity of about 6 cN/dtex to about 8 cN/dtex.

The fibers used to prepare the water soluble nonwoven webs of the disclosure can generally have any fineness. The fineness of the fiber correlates to how many fibers are present in a cross-section of a yarn of a given thickness. Fiber fineness is the ratio of fiber mass to length. The main physical unit of fiber fineness is 1 tex, which is equal to 1000 m of fiber weighing 1 g. Typically, the unit dtex is used, representing 1 g/10,000 m of fiber. The fineness of the fiber can be selected to provide a nonwoven web having suitable stiffness/hand-feel of the nonwoven web, torsional rigidity, reflection and interaction with light, absorption of dye and/or other actives/additives, ease of fiber spinning in the manufacturing process, and uniformity of the finished article. In general, as the fineness of the fibers increases the nonwovens resulting therefrom demonstrate higher uniformity, improved tensile strengths, extensibility and luster. Additionally, without intending to be bound by theory it is believed that finer fibers will lead to slower dissolution times as compared to larger fibers based on density. Further, without intending to be bound by theory, when a blend of fibers is used, the average fineness of the fibers can be determined using a weighted average of the individual fiber components. Fibers can be characterized as very fine (dtex≤1.22), fine (1.22≤dtex≤1.54), medium (1.54≤dtex≤1.93), slightly coarse (1.93≤dtex≤2.32), and coarse (dtex≥2.32). The nonwoven web of the disclosure can include fibers that are very fine, fine, medium, slightly coarse, or a combination thereof. In embodiments, the fibers have a fineness in a range of about 1 dtex to about 10 dtex, about 1 dtex to about 7 dtex, about 1 dtex to about 5 dtex, about 1 dtex to about 3 dtex, or about 1.7 dtex to about 2.2 dtex. In embodiments, fibers have a fineness of about 1.7 dtex. In embodiments, fibers have a fineness of about 2.2 dtex. In embodiments, the fibers include fibers having a fineness of about 1.7 dtex and fibers having a fineness of about 2.2 dtex.

Wet Cooled Gel Spinning

In embodiments, the plurality of water soluble fibers include water soluble fibers prepared according to a wet cooled gel spinning process, the wet cooled gel spinning process including the steps of

(a) dissolving the water soluble polymer (or polymers) in solution to form a polymer mixture, the polymer mixture optionally including auxiliary agents;
(b) extruding the polymer mixture through a spinning nozzle to a solidification bath to form an extruded polymer mixture;
(c) passing the extruded polymer mixture through a solvent exchange bath;
(d) optionally wet drawing the extruded polymer mixture; and
(e) finishing the extruded polymer mixture to provide the water soluble fibers.

The solvent in which the water soluble polymer is dissolved can suitably be any solvent in which the water soluble polymer is soluble. In embodiments, the solvent in which the water soluble polymer is dissolved includes a polar aprotic solvent. In embodiments, the solvent in which the water soluble polymer is dissolved includes dimethyl sulfoxide (DMSO).

In general, the solidification bath includes a cooled solvent for gelling the extruded polymer mixture. The solidification bath can generally be at any temperature that facilitates solidification of the extruded polymer mixture. The solidification bath can include a mixture of a solvent in which the polymer is soluble and a solvent in which the polymer is not soluble. The solvent in which the polymer is not soluble is generally the primary solvent, wherein the solvent in which the polymer is not soluble makes up greater than 50% of the mixture.

After passing through the solidification bath, the extruded polymer mixture gel can be passed through one or more solvent replacement baths. The solvent replacement baths are provided to replace the solvent in which the water soluble polymer is soluble with the solvent in which the water soluble polymer is not soluble to further solidify the extruded polymer mixture and replace the solvent in which the water soluble polymer is soluble with a solvent that will more readily evaporate, thereby reducing the drying time. Solvent replacement baths can include a series of solvent replacement baths having a gradient of solvent in which the water soluble polymer is soluble with the solvent in which the water soluble polymer is not soluble, a series of solvent replacement baths having only the solvent in which the water soluble polymer is not soluble, or a single solvent replacement bath having only the solvent in which the water soluble polymer is not soluble. In embodiments, at least one solvent replacement bath can consist essentially of a solvent in which the water soluble polymer is not soluble.

Finished fibers are sometimes referred to as staple fibers, shortcut fibers, or pulp. In embodiments, finishing includes drying the extruded polymer mixture. In embodiments, finishing includes cutting or crimping the extruded polymer mixture to form individual fibers. Wet drawing of the extruded polymer mixture provides a substantially uniform diameter to the extruded polymer mixture and, thus, the fibers cut therefrom. Drawing is distinct from extruding, as is well known in the art. In particular, extruding refers to the act of making fibers by forcing the resin mixture through the spinneret head whereas drawing refers to mechanically pulling the fibers in the machine direction to promote polymer chain orientation and crystallinity for increased fiber strength and tenacity.

In embodiments wherein the water soluble fibers are prepared from a wet cooled gel spinning process, the water soluble polymer can be generally any water soluble polymer or blend thereof, e.g., two or more different polymers, as generally described herein. In refinements of the foregoing embodiment, the polymer(s) can have any degree of polymerization (DP), for example, in a range of 10 to 10,000,000, for example, at least 10, at least 20, at least 50, at least 100, at least 200, at least 300, at least 400, at least 500, at least 750, or at least 1000 and up to 10,000,000, up to 5,000,000, up to 2,500,00, up to 1,000,000, up to 900,000, up to 750,000, up to 500,000, up to 250,000, up to 100,000, up to 90,000, up to 75,000, up to 50,000, up to 25,000, up to 12,000, up to 10,000, up to 5,000, or up to 2,500, for example in a range of 1000 to about 50,000, 1000 to about 25,000, 1000 to about 12,000, 1000 to about 5,000, 1000 to about 2,500, about 50 to about 12,000, about 50 to about 10,000, about 50 to about 5,000, about 50 to about 2,500, about 50 to about 1000, about 50 to about 900, about 100 to about 800, about 150 to about 700, about 200 to about 600, or about 250 to about 500. In embodiments, the DP is at least 1,000. Auxiliary agents, as described above, can be added to the fibers themselves or to the nonwoven web during the carding and/or bonding process.

Thermoplastic Fiber Spinning

Thermoplastic fiber spinning is well known in the art. Briefly, thermoplastic fiber spinning includes the steps of:

(a) preparing a polymer mixture including the fiber forming polymer optionally including auxiliary agents;
(b) extruding the polymer mixture through a spinneret nozzle to form an extruded polymer mixture;
(c) optionally drawing the extruded polymer mixture; and
(d) finishing the extruded polymer mixture to provide the fibers.

The finished staple fibers of the thermoplastic fiber spinning process can be finished by drying, cutting, and/or crimping to form individual fibers. Drawing of the extruded polymer mixture mechanically pulls the fibers in the machine direction, promoting polymer chain orientation and crystallinity for increased fiber strength and tenacity. The preparing the polymer mixture for thermoplastic fiber spinning can typically include (a) preparing a solution of a fiber-forming material and a readily volatile solvent such that after extruding the solution through the spinneret when the solution is contacted with a stream of hot air, the solvent readily evaporates leaving solid fibers behind or (b) melting the polymer such that after extruding the hot polymer through the spinneret, the polymer solidifies by quenching with cool air. The thermoplastic fiber spinning method is distinct from the wet cooled gel spun method at least in that (a) in the thermoplastic fiber spinning method the extruded fibers are solidified by evaporation of the solvent or by quenching hot solid fibers with cool air, rather than by use of a solidification bath; and (b) in the wet-cool gel spun method, the optional drawing is performed while the fibers are in a gel state rather than a solid state.

Fiber forming materials for preparing fibers from a thermoplastic fiber spinning process can be generally be any fiber forming polymer or blend thereof, e.g., two or more different polymers, provided that the polymer or blend thereof has suitable solubility in a readily volatile solvent and/or have a melting point lower than and distinct from their degradation temperature. Further, when a blend of fiber forming polymers are used to make a fiber, the fiber forming materials must have similar solubility in a readily volatile solvent and/or have similar heat profiles such that the two or more fiber forming materials will melt at similar temperatures. In contrast, the fiber forming materials for preparing fibers from the wet cooled gel spinning process are not as limited and fibers can be prepared from a blend of any two or more polymers that are soluble in the same solvent system, and the solvent system need not be a single solvent or even a volatile solvent.

The fiber forming polymer(s) for preparing thermoplastic fiber spun fibers can have a degree of polymerization (DP), for example, in a range of 10 to 10,000 for example, at least 10, at least 20, at least 50, at least 100, at least 200, at least 300, at least 400, at least 500, at least 750, or at least 1000 and up to 10,000, up to 5,000, up to 2,500, up to 1,000, up to 900, up to 750, up to 500, or up to 250. In embodiments, the DP is less than 1,000.

Melt Spinning

Melt spinning is well known in the art and is understood to refer to both spun bond processes and melt blown processes. Melt spinning is a continuous process which directly prepares a nonwoven web in-line with fiber formation. As such, the melt-spun formed fibers are not finished and cut to any consistent length (e.g., staple fibers are not prepared by these processes). Additionally, melt spinning does not include a drawing step and, therefore, the only control over the diameter of the resulting melt-spun fibers is the size of the holes through which the fiber forming materials are extruded, and the polymer chains are typically not oriented in any specific direction.

Briefly, melt spinning includes the steps of:

(a) preparing a polymer mixture including the fiber forming polymer optionally including auxiliary agents;
(b) extruding the polymer mixture into a die assembly to form an extruded polymer mixture;
(c) quenching the extruded polymer mixture;
(d) depositing the quenched, extruded polymer mixture on a belt to form a nonwoven web; and
(e) bonding the nonwoven web.

In the spun bond process, the extruded polymer mixture is pumped into the die assembly as molten polymer and quenched with cold air once passed through the die assembly. In the melt blown process, the extruded polymer mixture is pumped into a die assembly having hot air blown through it and is quenched upon exiting the die assembly and coming into contact with ambient temperature air. In both processes, the fibers are continuously dropped onto a belt or drum, usually facilitated by pulling a vacuum under the belt or drum.

The diameter of melt-spun fibers are generally in a range of about 0.1 to about 50 micron, for example, at least about 0.1 micron, at least about 1 micron, at least about 2 micron, at least about 5 micron, at least about 10 micron, at least about 15 micron, or at least about 20 micron and up to about 50 micron, up to about 40 micron, up to about 30 micron, up to about 25 micron, up to about 20 micron, up to about 15 micron, up to about 10 micron, about 0.1 micron to about 50 micron, about 0.1 micron to about 40 micron, about 0.1 micron to about 30 micron, about 0.1 micron to about 25 micron, about 0.1 micron to about 20 micron, about 0.1 micron to about 15 micron, about 0.1 micron to about 10 micron, about 0.1 micron to about 9 micron, about 0.1 micron to about 8 micron, about 0.1 micron to about 7 micron, about 0.1 micron to about 6 micron, about 0.1 micron to about 6 micron, about 5 micron to about 35 micron, about 5 micron to about 30 micron, about 7.5 micron to about 25 micron, about 10 micron to about 25 micron, or about 15 micron to about 25 micron. It is well known in the art that melt blown processes can provide micro-fine fibers having an average diameter in a range of about 1-10 micron, however, the melt blown process has very high variation in fiber-to-fiber diameter, e.g., 100-300% variation. Further, it is well known in the art that spun bond fibers can have larger average fiber diameters, e.g., typically about 15 to about 25 micron, but improved uniformity between fibers, e.g., about 10% variation.

The fiber forming material for heat extruded processes (e.g., melt-spun, thermoplastic fiber spinning) is more limited than for the wet-cooled gel spun process. In general, the degree of polymerization for heat extruding processes is limited to a range of about 200 to about 500. As the degree of polymerization decreases below 200, the viscosity of the fiber forming material is too low and the individual fibers prepared by pumping the material through the die assembly do not maintain adequate separation after exiting the die assembly. Similarly, as the degree of polymerization increases above 500, the viscosity is too high to efficiently pump the material through sufficiently small holes in the die assembly to run the process at high speeds, thus losing process efficiency and fiber and/or nonwoven uniformity. Further, processes requiring heating of the fiber forming material, are unsuitable for polyvinyl alcohol homopolymers as the homopolymers generally do not have the thermal stability required.

The wet cooled gel spinning process advantageously provides one or more benefits such as providing a fiber that includes a blend of water soluble polymers, providing control over the diameter of the fibers, providing relatively large diameter fibers, providing control over the length of the fibers, providing control over the tenacity of the fibers, providing high tenacity fibers, providing fibers from polymers having a large degree of polymerization, and/or providing fibers which can be used to provide a self-supporting nonwoven web. Continuous processes such as spun bond, melt blown, electro-spinning and rotary spinning generally do not allow for blending of water soluble polymers (e.g., due to difficulties matching the melt index of various polymers), forming large diameter (e.g., greater than 50 micron) fibers, controlling the length of the fibers, providing high tenacity fibers, and the use of polymers having a high degree of polymerization. Further, the wet cooled gel spinning process advantageously is not limited to polymers that are only melt processable and, therefore, can access fibers made from fiber forming materials having very high molecular weights, high melting points, low melt flow index, or a combination thereof, providing fibers having stronger physical properties and different chemical functionalities compared to fibers prepared by a heat extrusion process. Further still, advantageously, the wet cooled gel spinning process is not limited by the viscosity of the polymer. In contrast, it is known in the art that processes that require melting of the fiber forming material are limited to fiber forming materials having viscosities of 5 cP or less. Thus, fibers including polymers, including polyvinyl alcohol homopolymers and copolymers, having a viscosity of greater than 5 cP are only accessible by wet cooled gel spinning.

Nonwoven Web

The nonwoven webs of the disclosure are generally sheet-like structures having two exterior surfaces, the nonwoven webs including a plurality of fibers. The nonwoven webs of the disclosures can be prepared from fibers using any known methods in the art. As is known in the art, when fibers are spun bond or melt blown, the fibers are continuously laid down to form the nonwoven web, followed by bonding of the fibers.

Staple fibers can be carded or airlaid and bonded to provide a nonwoven web. Methods of carding and airlaying are well known in the art.

Methods of bonding nonwoven webs are well known in the art. In general, bonding can include thermal, mechanical, and/or chemical bonding. Thermal bonding can include, but is not limited to calendaring, embossing, air-through, and ultra-sound. Mechanical bonding can include, but is not limited to, hydro-entangling (spunlace), needle-punching, and stitch-bonding. Chemical bonding can include, but is not limited to, solvent bonding and resin bonding.

Thermal bonding is achieved by applying heat and pressure, and typically maintains the pore size, shape, and alignment produced by the carding process. The conditions for thermal bonding can be readily determined by one of ordinary skill in the art. In general, if the heat and/or pressure applied is too low, the fibers will not sufficiently bind to form a free-standing web and if the heat and/or pressure is too high, the fibers will begin to meld together. The fiber chemistry dictates the upper and lower limits of heat and/or pressure for thermal bonding. Without intending to be bound by theory, it is believed that at temperatures above 235° C., polyvinyl alcohol based fibers degrade. Methods of embossment for thermal bonding of fibers are known. The embossing can be a one-sided embossing or a double-sided embossing. Typically, embossing of water soluble fibers includes one-sided embossing using a single embossing roll consisting of an ordered circular array and a steel roll with a plain surface. As embossing is increased (e.g., as surface features are imparted to the web), the surface area of the web is increased. Without intending to be bound by theory it is expected that as the surface are of the web is increased, the solubility of the web is increased. Accordingly, the solubility properties of the nonwoven web can be advantageously tuned by changing the surface area through embossing.

Air-through bonding generally requires a high thermoplastic content in the nonwoven web and two different melting point materials. In air-through bonding, the nonbonded nonwoven web is circulated around a drum while hot air flows from the outside of the drum toward the center of the drum. Air-through bonding can provide nonwovens having low density and higher basis weight (e.g., greater than 20 to about 2000 g/m²). Nonwovens bonded by air-bonding a typically very soft.

Chemical bonding generally includes solvent bonding and resin bonding. In particular, chemical bonding typically uses a binder solution of a solvent and a resin (e.g., latex or the waste polymer left over from preparing the fibers). The nonwoven can be coated with the binder solution and heat and pressure applied to cure the binder and bond the nonwoven. The binder solution can be applied by immersing the nonwoven in a bath of binder solution, spraying the binder solution onto the nonwoven, extruding the binder solution onto the web (foam bonding), and/or applying the binder solution as a print or gravure.

Chemical bonding can result in smaller, less ordered pores relative to the pores as carded/melt-spun. Without intending to be bound by theory, it is believed that if the resin solution used for chemical bonding is sufficiently concentrated and/or sufficient pressure is applied, a nonporous water-dispersible nonwoven web can be formed. The solvent used in chemical bonding induces partial solubilization of the existing fibers in the web to weld and bond the fibers together. Thus, in general, the solvent for chemical bonding can be any solvent that can at least partially solubilize one or more fiber forming materials of the fibers of the nonwoven. In embodiments, the solvent is selected from the group consisting of water, ethanol, methanol, DMSO, glycerin, and a combination thereof. In embodiments, the solvent is selected from the group consisting of water, glycerin, and a combination thereof. In embodiments, the binder solution comprises a solvent selected from the group consisting of water, ethanol, methanol, DMSO, glycerin, and a combination thereof and further comprises a resin selected from the group consisting of polyvinyl alcohol, latex, and polyvinylpyrrolidone. The binder provided in the solution assists in the welding process to provide a more mechanically robust web. The temperature of the polymer solution is not particularly limited and can be provided at room temperature (about 23° C.).

In some embodiments, a second layer of fibers can be used to bond the nonwoven web. In embodiments, at least one nonwoven layer of the composite articles of the disclosure are bonded using a second layer of nonwoven web/fibers. In embodiments, at least two nonwoven layers of the composite articles of the disclosure are bonded using an additional layer of nonwoven web/fibers. In embodiments, at least one nonwoven layer of the composite articles of the disclosure are bonded using thermal, mechanical, or chemical bonding, alone or in addition to bonding using an additional layer of nonwoven web/fibers.

Pore sizes can be determined using high magnificiation and ordered surface analysis techniques including, but not limited to Brunauer-Emmett-Teller theory (BET), small angle X-ray scattering (SAXS), and molecular adsorption.

Nonwoven webs can be characterized by basis weight. The basis weight of a nonwoven is the mass per unit area of the nonwoven. Basis weight can be modified by varying manufacturing conditions, as is known in the art. A nonwoven web can have the same basis weight prior to and subsequent to bonding. Alternatively, the bonding method can change the basis weight of the nonwoven web. For example, wherein bonding occurs through the application of heat and pressure, the thickness of the nonwoven (and, thus, the area of the nonwoven) can be decreased, thereby increasing the basis weight. Accordingly, as used herein and unless specified otherwise, the basis weight of a nonwoven refers to the basis weight of the nonwoven subsequent to bonding.

The nonwoven webs of the disclosure can generally have any basis weight in a range of about 0.1 g/m² to about 700 g/m², about 0.5 g/m² to about 600 g/m², about 1 g/m² to about 500 g/m², about 1 g/m² to about 400 g/m², about 1 g/m² to about 300 g/m², about 1 g/m² to about 200 g/m², about 1 g/m² to about 100 g/m², about 30 g/m² to about 100 g/m², about 20 g/m² to about 100 g/m², about 20 g/m² to about 80 g/m², or about 25 g/m² to about 70 g/m².

The nonwoven webs of the disclosure can generally have any thickness. Suitable thicknesses can include, but are not limited to, about 5 to about 10,000 μm (1 cm), about 5 to about 5,000 μm, about 5 to about 1,000 μm, about 5 to about 500 μm, about 200 to about 500 μm, about 5 to about 200 μm, about 20 to about 100 μm, or about 40 to about 90 μm, or about 50 to 80 μm, or about or about 60 to 65 μm for example 50 μm, 65 μm, 76 μm, or 88 μm.

The nonwoven webs of the disclosure can be characterized as high loft or low loft. In general, loft refers to the ratio of thickness to mass per unit area (i.e., basis weight). High loft nonwoven webs can be characterized by a high ratio of thickness to mass per unit area. As used herein, “high loft” refers to a nonwoven web of the disclosure having a basis weight as defined herein and a thickness exceeding 200 μm. The thickness of the nonwoven web can be determined by according to ASTM D5729-97, ASTM D5736, and ISO 9073-2: 1995 and can include, for example, subjecting the nonwoven web to a load of 2 N and measuring the thickness. High loft materials can be used according to known methods in the art, for example, thru-air bonding or cross-lapping, which uses a cross-lapper to fold the unbounded web over onto itself to build loft and basis weight. Without intending to be bound by theory, in contrast to water soluble nonwoven webs wherein the solubility of the nonwoven web can be dependent on the thickness of the nonwoven web; the solubility of a nonwoven web is not believed to be dependent on the thickness of the web. In this regard, it is believed that because the individual fibers provide a higher surface area than a water soluble film, regardless of the thickness of the nonwoven web, the parameter that limits approach of water to the fibers and, ultimately, dissolution of the fibers is the basis weight (i.e., fiber density in the nonwoven).

The solubility of the water soluble nonwoven webs of the disclosure is generally a function of the type of fiber(s) used to prepare the web as well as the basis weight of the water soluble web. Without intending to be bound by theory, it is believed that the solubility profile of a nonwoven web follows the same solubility profile of the fiber(s) used to prepare the nonwoven web, and the solubility profile of the fiber generally follows the same solubility profile of the polymer(s) from which the fiber is prepared. For example, for nonwoven webs comprising PVOH fibers, the degree of hydrolysis of the PVOH polymer can be chosen such that the water-solubility of the nonwoven web is also influenced. In general, at a given temperature, as the degree of hydrolysis of the PVOH polymer increases from partially hydrolyzed (88% DH) to fully hydrolyzed (98% DH), water solubility of the polymer generally decreases. Thus, in one option, the water soluble nonwoven web can be cold water soluble. For a co-poly(vinyl acetate vinyl alcohol) polymer that does not include any other monomers (e.g., not copolymerized with an anionic monomer) a cold water soluble web, soluble in water at a temperature of less than 10° C., can include fibers of PVOH with a degree of hydrolysis in a range of about 75% to about 90%, or in a range of about 80% to about 90%, or in a range of about 85% to about 90%. In another option the water soluble nonwoven web can be hot water soluble. For a co-poly(vinyl acetate vinyl alcohol) polymer that does not include any other monomers (e.g., not copolymerized with an anionic monomer) a hot water soluble web, soluble in water at a temperature of at least about 60° C., can include fibers of PVOH with a degree of hydrolysis of at least about 98%.

Modification of PVOH generally increases the solubility of the PVOH polymer. Thus, it is expected that at a given temperature the solubility of a water soluble nonwoven web prepared from a PVOH copolymer, would be higher than that of a nonwoven web prepared from a PVOH homopolymer having the same degree of hydrolysis as the PVOH copolymer. Following these trends, a water soluble nonwoven web having specific solubility characteristics can be designed by blending polymers within the fibers and/or fibers within the nonwoven web.

Further, as the basis weight of the web increases the rate of dissolution of the web decreases, provided the fiber composition remains constant, as there is more material to be dissolved. For example, at a given temperature, a water soluble web prepared from fibers comprising PVOH polymer(s) and having a basis weight of, e.g., 40 g/m², is expected to dissolve slower than an otherwise-identical water soluble web having a basis weight of, e.g., 30 g/m². Accordingly, basis weight can also be used to modify the solubility characteristics of the water soluble nonwoven web. The water soluble nonwoven web can generally have any basis weight in a range of about 1 g/m² to about 700 g/m², about 1 g/m² to about 600 g/m², about 1 g/m² to about 500 g/m², about 1 g/m² to about 400 g/m², about 1 g/m² to about 300 g/m², about 1 g/m² to about 200 g/m², about 10 g/m² to about 100 g/m², about 30 g/m² to about 100 g/m², about 20 g/m² to about 100 g/m², about 20 g/m² to about 80 g/m², about 25 g/m² to about 70 g/m², or about 40 g/m² to about 60 g/m².

Without intending to be bound by theory, it is believed that solubility (in terms of time to complete dissolution) of a water soluble nonwoven web is expected to surpass that of a water soluble film of the same size (L×W) and/or mass, prepared from the same PVOH polymer. This is due to the higher surface area found in the nonwoven compared to a film, leading to faster solubilization. As shown in the Examples, below, a nonwoven web prepared from a PVOH homopolymer having a degree of hydrolysis of 88% dissolves in 14 seconds, while a water soluble film of similar size and prepared from the same PVOH homopolymer having a degree of hydrolysis of 88% dissolves in ˜100 seconds.

The tenacity of the water soluble nonwoven web can be the same or different from the tenacity of the fibers used to prepare the web. Without intending to be bound by theory, it is believed that the tenacity of the nonwoven web is related to the strength of the nonwoven web, wherein a higher tenacity provides a higher strength to the nonwoven web. In general, the tenacity of the nonwoven web can be modified by using fibers having different tenacities. The tenacity of the nonwoven web may also be affected by processing. In general, the water soluble webs of the disclosure have relatively high tenacities, i.e., the water soluble nonwoven web is a self-supporting web that can be used as the sole material for preparing an article and/or pouch. In contrast, nonwoven webs prepared according to melt blown, electro-spinning, and/or rotary spinning processes typically have low tenacities, and may not be self-supporting or capable of being used as a sole web for forming an article or pouch.

In general, the coefficient of dynamic friction and the ratio of the coefficient of static friction to the coefficient of dynamic friction for a water soluble nonwoven web of the disclosure will be lower than the coefficient of dynamic friction and the ratio of the coefficient of static friction to the coefficient of dynamic friction for a water soluble film due to the increased surface roughness of the nonwoven web relative to a water soluble film, which provides decreased surface contact to the nonwoven web. Advantageously, this surface roughness can provide an improved feel to the consumer (i.e., a cloth-like hand-feel instead of a rubbery hand-feel), improved aesthetics (i.e., less glossy than a water soluble film), and/or facilitate processability in preparing thermoformed, and/or vertical formed, filled, and sealed, and/or multichamber packets which require drawing the web along a surface of the processing equipment/mold. Accordingly, the fibers should be sufficiently coarse to provide a surface roughness to the resulting nonwoven web without being so coarse as to produce drag.

The water soluble nonwoven web of the disclosure can be used as a single layer or can be layered with other water soluble nonwoven webs, or can be in the form of a laminate with a water soluble film. In some embodiments, the water soluble nonwoven web includes a single layer of water soluble nonwoven web. In some embodiments, the water soluble nonwoven web is a multilayer water soluble nonwoven web comprising two or more layers of water soluble nonwoven webs. The one or more layers can be laminated to each other. In refinements of the foregoing embodiment, the two or more layers can be the same (e.g., be prepared from the same fibers and basis weight). In refinements of the foregoing embodiment, the two or more layers can be different (e.g., be prepared from different types of fibers and/or have different basis weights).

In general, a multilayer water soluble nonwoven web can have a basis weight that is the sum of the basis weights of the individual layers. Accordingly, a multilayer water soluble nonwoven web will take longer to dissolve than any of the individual layers provided as a single layer.

In embodiments, the water soluble nonwoven web of the disclosure has a disintegration time of no more than 300 seconds according to MSTM 205 in 23° C. water after exposure to a TCCA, SBS, or calcium hypochlorite composition for 6 or 8 weeks in a 38° C. and 80% RH atmosphere.

In embodiments, the surface area of the nonwoven web residue after testing according to MSTM 205 in 23° C. water after exposure to a TCCA, SBS, or calcium hypochlorite composition for 6 or 8 weeks in a 38° C. and 80% RH atmosphere is less than about 50% of the surface area of the nonwoven web prior to testing according to MSTM 205.

In embodiments, the nonwoven web maintains a b* value of no more than 3.5, or no more than 3.0, or no more than 2.5 after exposure to TCCA, SBS, or calcium hypochlorite composition for 6 or 8 weeks in a 38° C. and 80% RH atmosphere. In embodiments, the nonwoven web maintains a b* value of no more than 3.5 after exposure to TCCA, SBS, or calcium hypochlorite composition for 6 or 8 weeks in a 38° C. and 80% RH atmosphere. In embodiments, the nonwoven web maintains a b* value of no more than 3.0 after exposure to TCCA, SBS, or calcium hypochlorite composition for 6 or 8 weeks in a 38° C. and 80% RH atmosphere. In embodiments, the nonwoven web maintains a b* value of no more than 2.5 after exposure to TCCA, SBS, or calcium hypochlorite composition for 6 or 8 weeks in a 38° C. and 80% RH atmosphere.

Further provided herein is a water soluble unit dose article comprising a water soluble nonwoven web as described herein in the form of a packet comprising an outer wall, the outer wall having an exterior surface and an interior surface defining an interior pouch volume and a composition contained in the interior pouch volume. In embodiments, the composition can comprise a harsh chemical. In embodiments, the harsh chemical can comprise an acid, an oxidant, a base, or a composition thereof. In embodiments, the harsh chemical can comprise an acid. In embodiments, the harsh chemical can comprise an oxidant. In embodiments, the harsh chemical can comprise a base.

Also provided herein is a unit dose article comprising a packet comprising an outer wall, the outer wall having an exterior surface and an interior surface defining an interior pouch volume, the outer wall comprising a nonwoven web comprising a plurality of fibers comprising a sulfonate modified PVOH fiber forming material comprising a sulfonated anionic monomer unit; wherein the sulfonate modified PVOH fiber forming material has a degree of hydrolysis of at least 95% and the sulfonated anionic monomer is present in an amount in a range of about 1 mol % to about 5 mol %; and a composition contained in the interior pouch volume. In embodiments, the composition can comprise a harsh chemical. In embodiments, the harsh chemical can comprise an oxidant, a base, or a composition thereof. In embodiments, the harsh chemical can comprise an oxidant. In embodiments, the oxidant is a base-mediated oxidant. In embodiments, the base-mediated oxidant can comprise calcium hypochlorite.

Also provided herein is a unit dose article comprising a packet comprising an outer wall, the outer wall having an exterior surface and an interior surface defining an interior pouch volume, the outer wall comprising a nonwoven web comprising a plurality of fibers comprising (i) polyvinylpyrrolidone, and (ii) a sulfonate modified polyvinyl alcohol (PVOH), a carboxyl modified PVOH, or both; and a composition contained in the interior pouch volume. In embodiments, the composition can comprise a harsh chemical. In embodiments, the harsh chemical can comprise an acid, an oxidant, a base, or a composition thereof. In embodiments, the harsh chemical can comprise an acid. In embodiments, the harsh chemical can comprise an oxidant. In embodiments, the harsh chemical can comprise a base.

In embodiments, the harsh chemical can comprise one or more of a hypochlorite, hypochlorous acid, a halogenated isocyanurate, a chlorate, a chlorite, a perchlorate, a bromate, a perbromate, a halogenated hydantoin, a perborate, a periodate, a persulfate, a permanganate, a chromate, a dichromate, a nitrate, a nitrite, a peroxide, a ketone peroxide, a peroxy acid, citric acid, muriatic acid, and an inorganic acid, such as, one or more of sodium bisulfate (SBS), cyanuric acid, dichloroisocyanuric acid, trichloroisocyanuric acid (TCCA), and calcium hypochlorite. In embodiments, the compositions can be both an acid and an oxidant, such as trichloroisocyanuric acid. In embodiments, the harsh chemical can comprise a hypochlorite. In embodiments, the harsh chemical can comprise calcium hypochlorite.

In embodiments, the harsh chemical can include a chlorine liberating compound. In embodiments, the acid, oxidant, base, or a combination thereof can comprise a chlorine liberating compound. As used herein, the term “chlorine liberating compound” refers to a family of chemicals that release chlorine or chloride upon contact with water. Chlorine liberating compounds are commonly used as bleaching materials, water disinfectants, medical equipment disinfectants, as well as other disinfectant purposes.

In one embodiment, for instance, the oxidant may comprise hypochlorous acid, a hypochlorite, a halogenated isocyanurate, such as sodium dichloroisocyanurate, a chlorate, a chlorite, a perchlorate, a bromate, a perbromate, a halogenated hydantoin, a perborate, a periodate, a persulfate, a permanganate, a chromate, a dichromate, a nitrate, a nitrite, a peroxide, a ketone peroxide, a peroxy acid, an inorganic acid, or a combination thereof. In embodiments, the oxidant comprises trichloroisocyanuric acid. In embodiments, the oxidant can include trichloroisocyanuric acid (TCCA), dichloroisocyanuric acid (DCCA), 1-Bromo-3-chloro-5,5-dimethylhydantoin (BCDMH), calcium hypochlorite (Cal-Hypo), potassium peroxymonosulfate (MPS). In embodiments, the harsh chemical can comprise a base-mediated oxidant. In embodiments, the base-mediated oxidant can comprise a hypochlorite. In embodiments, the base-mediated oxidant can comprise calcium hypochlorite. In embodiments, the harsh chemical can comprise an acid-mediated oxidant. As used herein, the term “acid-mediated oxidant” refers to an oxidant that oxidizes another chemical species using an acidic mechanistic pathway to oxidation, such as that shown in Scheme 2. In general, an acid-mediated oxidant includes any oxidizing compound including an acid stabilizing molecule. In embodiments, the acid-mediated oxidant can comprise TCCA, DCCA, BCDMH, or combinations thereof. In embodiments, the acid-mediated oxidant can comprise a halogenated isocyanurate. In embodiments, the acid-mediated oxidant can comprise TCCA, DCCA, or a combination thereof. In embodiments, the acid-mediated oxidant can comprise BCDMH.

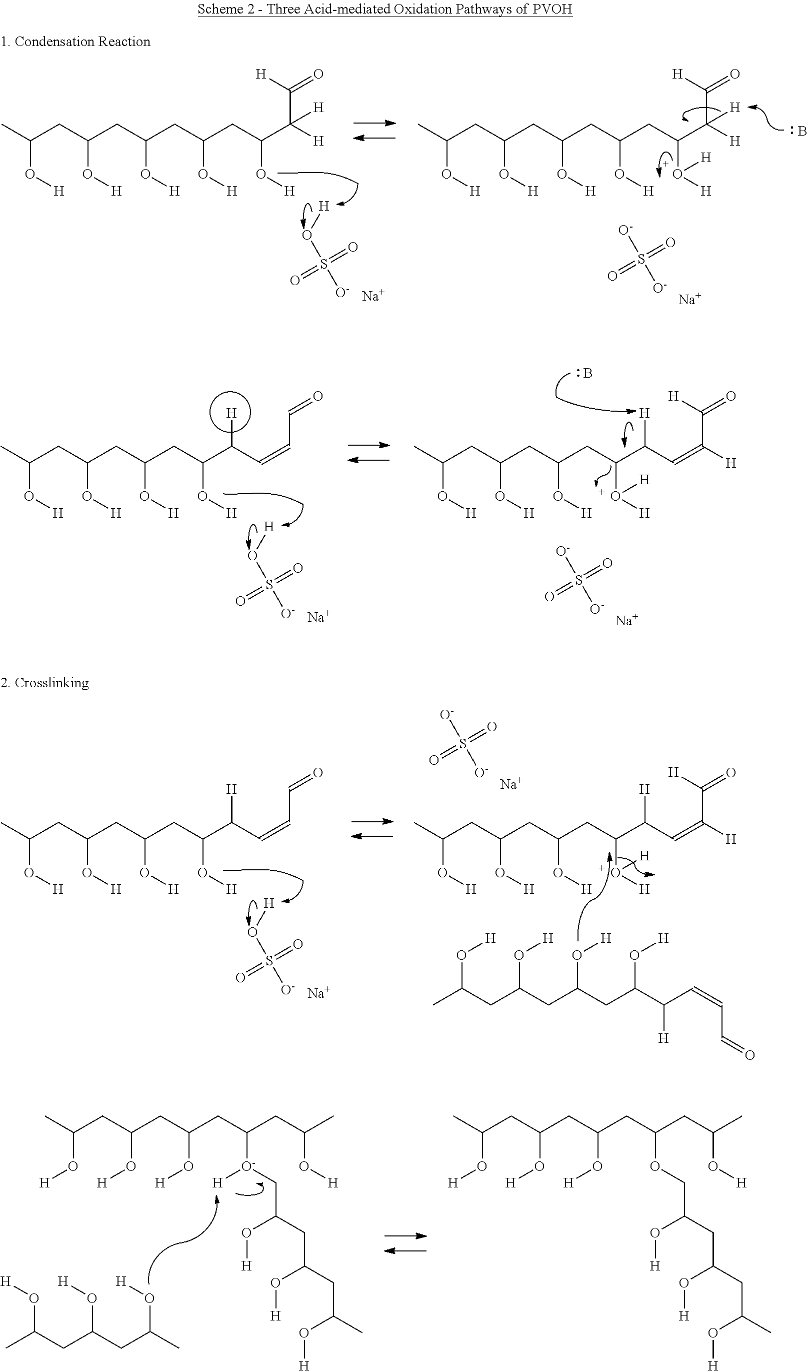

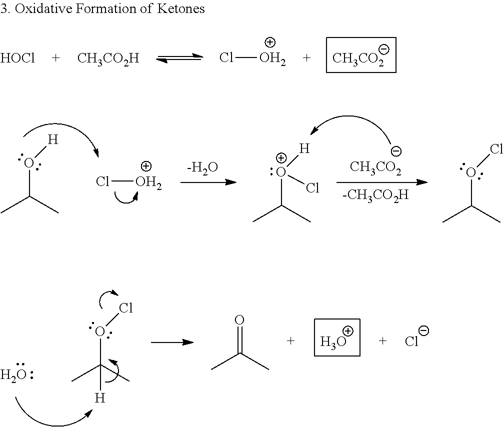

It has been advantageously found that the unit dose articles as disclosed herein can have an unexpected, selective resistance to base-mediated oxidants relative to acid-mediated oxidants. For example, a nonwoven web comprising fibers comprising an AMPS modified PVOH nonwoven web, when exposed to TCCA (acid-mediated oxidant) or, separately, calcium hypochlorite (base-mediated oxidants), for 2, 4, and 6 weeks in a 38° C. and 80% RH atmosphere, demonstrated very different results. Although both TCCA and calcium hypochlorite are oxidants, the nonwoven web comprising the AMPS modified PVOH performed well when exposed to calcium hypochlorite and did not perform as well when exposed to TCCA. In particular, when exposed to calcium hypochlorite for 6 weeks in a 38° C. and 80% RH atmosphere, the nonwoven web maintained acceptable disintegration (e.g., 100% disintegration in less than 300 seconds) according to the Dissolution, Disintegration, and % Residue Test (MSTM 205), resisted discoloration according to the CIELab Test, (e.g., had a b* value of less than 3), and maintained acceptable elongation % according to the Elongation Test (e.g., less than 15%). However, a nonwoven having the same composition, when exposed to TCCA for just 2 weeks in 38° C. and 80% RH atmosphere, demonstrated unacceptable disintegration (e.g., disintegration takes longer than 300 seconds) according to MSTM 205, demonstrated unacceptable discoloration (e.g., a b* value greater than 3), and further demonstrated unacceptable elongation % (e.g., greater than 15%). Without intending to be bound by theory, it is believed that the differing mechanistic pathways of each oxidant provides the varying results in performance.

In embodiments, the acid can comprise acids that have a pH in a range of −2 to 6.5 in a 1% water solution, or −1 to 6 in a 1% water solution, or 0 to 5 in a 1% water solution, or 1 to 5 in a 1% water solution, or 1 to 4 in a 1% water solution. In embodiments, the acid can comprise sodium bisulfate, cyanuric acid, dichloroisocyanuric acid, trichloroisocyanuric acid, citric acid, muriatic acid, or a combination thereof. In embodiments, the acid can comprise sodium bisulfate, cyanuric acid, dichloroisocyanuric acid, trichloroisocyanuric acid, or a combination thereof.

In embodiments, the base can include sodium carbonate, sodium bicarbonate, or a combination thereof.

In embodiments, the water soluble unit dose article can comprise a non-household care composition. The non-household care composition can be selected from agricultural compositions, aviation compositions, food and nutritive compositions, industrial compositions, livestock compositions, marine compositions, medical compositions, mercantile compositions, military and quasi-military compositions, office compositions, recreational and park compositions, pet compositions, a pool and/or water-treatment composition, and a combination thereof. In embodiments, the non-household care composition is a pool and/or water-treatment composition.

In embodiments, the water soluble unit dose article can comprise a harsh chemical composition comprising a concentration of acid, oxidant, base, or combination thereof in a range of 50 wt % to 100 wt %, or 60 wt % to 100 wt %, or 70 wt % to 100 wt %, or 80 wt % to 100 wt %, or 90 wt % to 100 wt %, based on the total weight of the composition. In embodiments, the concentration of acid, oxidant, base, or combination thereof in the non-household care composition of the water soluble unit dose article is in a range of 50 wt % to 100 wt %, or 60 wt % to 100 wt %, or 70 wt % to 100 wt %, or 80 wt % to 100 wt %, or 90 wt % to 100 wt %, based on the total weight of the non-household care composition.

In embodiments, the packet can further comprise a first coating comprising an acid scavenger and/or antioxidant, the first coating being in contact with the water soluble nonwoven web. In embodiments, the first coating comprising an acid scavenger, an antioxidant, or a combination thereof can be provided on at least a portion of the interior surface of the outer wall. In embodiments, the first coating comprising an acid scavenger, an antioxidant, or a combination thereof can be provided on at least a portion of the exterior surface of the outer wall. In embodiments, the packet further comprises a second coating comprising an acid scavenger, an antioxidant, or both. In embodiments, the first coating is provided on at least a portion of the interior surface of the outer wall and the second coating is provided on at least a portion of the exterior surface of the pouch.

The first and/or second coating of the water soluble unit dose article described herein can be provided on the outer wall using any suitable method known in the art, for example, solution coating such as, spin coating, dip coating, brush coating, and spray coating.

The acid scavenger and/or antioxidant provided in the first and/or second coating can be any acid scavenger and/or antioxidant disclosed herein. In embodiments, the acid scavenger comprises N-vinyl pyrrolidone, sodium metabisulfite, zinc oxide, hydrotalcite, metallic stearate, activated olefins, allylic compounds, carboxylate compounds, ethylene containing compounds, quaternary ammonium compounds, tertiary amine containing compounds, and a combination thereof. In embodiments, the antioxidant comprises propyl gallate, gallic acid, phenolic compounds, hindered amines, sodium metabisulfite, zinc acetate, and a combination thereof.

Further provided is a water soluble unit does article including water soluble nonwoven web according to the disclosure in the form of a packet having an outer wall having an exterior surface and an interior surface defining an interior pouch volume and a pool and/or water-treatment composition contained in the interior pouch volume, the concentration of the harsh chemical in the pool and/or water-treatment composition is in a range of 50% to 100% by weight, and wherein the packet optionally includes a first coating comprising an acid scavenger provided on at least a portion of the interior surface of the outer wall.

In embodiments, the unit dose article disclosed herein comprising the plurality of fibers comprising a sulfonate modified PVOH fiber forming material comprising a sulfonated anionic monomer unit, wherein the sulfonate modified PVOH fiber forming material has a degree of hydrolysis of at least 95% and the sulfonated anionic monomer is present in an amount in a range of about 1 mol % to about 5 mol %, can comprise a pool and/or water-treatment composition contained in the interior pouch volume, the pool and/or water-treatment composition can comprise calcium hypochlorite in a range of 50% to 100% by weight of the pool and/or water-treatment composition. In embodiments, the packet comprises a first coating comprising an acid scavenger provided on at least a portion of the interior surface of the outer wall.

In embodiments, the unit dose article disclosed herein comprising the plurality of fibers comprising a blend of fiber forming materials comprising (i) polyvinylpyrrolidone and (ii) a sulfonate modified PVOH, a carboxyl modified PVOH, or both, can comprise a pool and/or water-treatment composition contained in the interior pouch volume, the pool and/or water-treatment composition can comprise calcium hypochlorite in a range of 50% to 100% by weight of the pool and/or water-treatment composition. In embodiments, the packet comprises a first coating comprising an acid scavenger provided on at least a portion of the interior surface of the outer wall.

Further provided herein is a process for dosing a composition of bulk water comprising the steps of contacting with bulk water a water soluble unit dose article as described herein, thereby dissolving at least a portion of the water soluble nonwoven web, and releasing the composition to the bulk water. In embodiments, the water soluble unit dose article can comprise a water soluble nonwoven web as described herein in the form of a packet defining an interior pouch volume and the composition to be dosed enclosed within the interior pouch volume, wherein the water soluble nonwoven web can comprise a water soluble mixture of a PVOH and a PVP. In embodiments, the PVOH and the PVP are present in a ratio of about 95%:5% by weight to about 25%:75% by weight, respectively.

Further provided herein is a process for dosing a composition to bulk water comprising the step of contacting with the bulk water a unit dose article of the disclosure. In embodiments, the bulk water dissolves at least a portion of the nonwoven web, and releasing the composition into the bulk water. In embodiments, the nonwoven web of the unit dose article can comprise a plurality of fibers comprising a blend of fiber forming materials comprising (i) polyvinylpyrrolidone, and (ii) a sulfonate modified polyvinyl alcohol (PVOH), a carboxyl modified PVOH, or both. In embodiments, the nonwoven web of the unit dose article can comprise a plurality of fibers comprising a sulfonate modified PVOH fiber forming material comprising a sulfonated anionic monomer unit, wherein the sulfonate modified PVOH fiber forming material has a degree of hydrolysis of at least 95% and the sulfonated anionic monomer is present in an amount in a range of about 1 mol % to about 5 mol %. In general, the bulk water can be any bulk water which requires a non-household care composition provided therein. In embodiments, the bulk water can be a pool or a spa. In general, the temperature of the bulk water can be any temperature sufficient to dissolve or disintegrate at least a portion of the water soluble nonwoven web. In embodiments, the bulk water has a temperature of at least about 10° C., for example, in a range of about 10° C. to about 100° C., about 10° C. to about 70° C., about 10° C. to about 60° C., about 20° C. to about 50° C., or about 20° C. to about 40° C. In general, the bulk water can have any pH. In embodiments, the pH of the bulk water can be in a range of about 4 to about 10, about 5 to about 9, or about 6 to about 7.

Specific contemplated embodiments of the disclosure herein are described in the following numbered paragraphs.

1. A water soluble nonwoven web comprising: a plurality of fibers comprising (a) a blend of fiber forming materials comprising

(i) a carboxyl modified polyvinyl alcohol (PVOH), and (ii) a sulfonate modified polyvinyl alcohol, polyvinylpyrrolidone, or both; (b) a blend of fibers comprising (iii) a fiber comprising a carboxyl modified polyvinyl alcohol fiber forming material, and (iv) a fiber comprising a sulfonate modified polyvinyl alcohol fiber forming material, a fiber comprising a polyvinylpyrrolidone fiber forming material, or both; or (c) a blend of fibers comprising (v) a first fiber comprising a carboxyl modified polyvinyl alcohol fiber forming material, a sulfonate modified polyvinyl alcohol fiber forming material, or a polyvinylpyrrolidone fiber forming material, and (vi) a second fiber comprising a blend of fiber forming materials comprising a carboxyl modified polyvinyl alcohol fiber forming material, a sulfonate modified polyvinyl alcohol fiber forming material, a polyvinylpyrrolidone fiber forming material or a combination thereof; wherein in any of (a), (b), and (c), the weight ratio of the carboxyl modified PVOH fiber forming material to the sulfonate modified PVOH and/or polyvinylpyrrolidone fiber forming materials is about 3:1 to about 19:1 by weight, respectively.

2. The water soluble nonwoven web of paragraph 1, wherein the weight ratio of the carboxyl modified polyvinyl alcohol fiber forming material to the sulfonate and/or polyvinylpyrrolidone fiber forming materials is about 5:1 to about 15:1 by weight, about 5:1 to about 12:1 by weight, about 5:1 to about 9:1 by weight, about 6:1 to about 9:1 by weight, or about 6.5:1 to about 7.5:1 by weight, respectively.

3. The water soluble nonwoven web of any one of the preceding paragraphs, wherein the carboxyl modified PVOH comprises a maleate monomer unit selected from the group consisting of monomethyl maleate, maleic acid, maleic anhydride, alkali salts thereof, and a combination thereof.

4. The water soluble nonwoven web of paragraph 3, wherein the maleate monomer unit is present in an amount in a range of about 1 mol % to 10 mol %, or about 1 mol % to 8 mol %, or about 1 mol % to 5 mol %.

5. The water soluble nonwoven web of any one of the preceding paragraphs, wherein the sulfonate modified PVOH comprises a sulfonated anionic monomer unit selected from the group consisting of vinyl sulfonic acid, allyl sulfonic acid, ethylene sulfonic acid, 2-acrylamido-1-methylpropanesulfonic acid, 2-acrylamido-2-methylpropanesulfonic acid (AMPS), 2-methylacrylamido-2-methylpropanesulfonic acid, 2-sulfoethyl acrylate, alkali salts thereof, or a combination thereof.

6. The water soluble nonwoven web of paragraph 5, wherein the sulfonated anionic monomer is present in an amount in a range of about 1 mol % to 10 mol %, or about 1 mol % to 8 mol %, or about 1 mol % to 5 mol %.

7. The water soluble nonwoven web of any one of the preceding paragraphs, wherein the fiber forming material of (a) comprises polyvinylpyrrolidone, the fibers of (b) comprises polyvinylpyrrolidone, or the second fiber of (c) comprises polyvinylpyrrolidone fiber forming material.

8. The water soluble nonwoven web of any one of the preceding paragraphs, wherein the plurality of fibers further comprises cellulosic modifiers, starch modifiers, or both.

9. The water soluble nonwoven web of any one of the preceding paragraphs, further comprising an acid scavenger.

10. The water soluble nonwoven web of paragraph 9, wherein the acid scavenger is selected from the group consisting of N-vinyl pyrrolidone, sodium metabisulfite, activated olefins, allylic compounds, ethylene containing compounds, quaternary ammonium compounds, tertiary amine containing compounds, and a combination thereof.

11. The water soluble nonwoven web of paragraph 9 or 10, wherein the acid scavenger is provided in or on the fiber, in or on the nonwoven web, or a combination of the foregoing.

12. The water soluble nonwoven web of paragraph 11, wherein the acid scavenger is coated on the fiber, coated on the nonwoven web, or both.

13. The water soluble nonwoven web of paragraph 11, wherein the acid scavenger is dispersed throughout the nonwoven web.

14. The water soluble nonwoven web of any one of the preceding paragraphs, further comprising an antioxidant.

15. The water soluble nonwoven web of paragraph 14, wherein the antioxidant is selected from the group consisting of propyl gallate, gallic acid, phenolic compounds, hindered amines, sodium metabisulfite, zinc acetate, and a combination thereof.

16. The water soluble nonwoven web of paragraph 14 or 15, wherein the antioxidant is provided in or on the fiber, in or on the nonwoven web, or a combination of the foregoing.

17. The water soluble nonwoven web of paragraph 16, wherein the antioxidant is coated on the fiber, coated on the nonwoven web, or both.

18. The water soluble nonwoven web of paragraph 16, wherein the antioxidant is dispersed throughout the nonwoven web.

19. The water soluble nonwoven web of any one of the preceding paragraphs, further comprising a plasticizer.

20. The water soluble nonwoven web of paragraph 19, wherein the plasticizer is selected from the group consisting of glycerin, diglycerin, sorbitol, ethylene glycol, diethylene glycol, triethylene glycol, dipropylene glycol, tetraethylene glycol, propylene glycol, polyethylene glycols up to 400 MW, neopentyl glycol, trimethylolpropane, polyether polyols, 2-methyl-1,3-propanediol, ethanolamines, maltitol, and a combination thereof.

21. The water soluble nonwoven web of paragraph 20, wherein the plasticizer is selected from the group consisting of glycerol, maltitol, trimethylolpropane, and a combination thereof.

22. The water soluble nonwoven web of any one of the preceding paragraphs, further comprising a filler.

23. The water soluble nonwoven web of paragraph 22, wherein the filler is selected from the group consisting of high amylose starch, amorphous silica, hydroxyethylated starch, and a combination thereof.

24. The water soluble nonwoven web of any one of the preceding paragraphs, further comprising a surfactant.

25. The water soluble nonwoven web of paragraph 24, wherein the surfactant comprises quaternary amines, myristyl dimethyl amine oxide, alkyl polyethylene glycol ether, cocamides, or a combination thereof.

26. The water soluble nonwoven web of any one of paragraphs 1 to 25, wherein the nonwoven web has a disintegration time of no more than 300 seconds according to MSTM 205 in 23° C. water after exposure to a trichloroisocyanuric acid (TCCA) or sodium bisulfate (SBS) composition for 8 weeks in a 38° C. and 80% RH atmosphere.

27. The water soluble nonwoven web of paragraph 26, wherein the surface area of the nonwoven web residue after testing according to MSTM 205 in 23° C. is less than about 50% of the surface area of the nonwoven web prior to testing according to MSTM 205.

28. The water soluble nonwoven web of any one paragraphs 1 to 27, wherein the nonwoven web maintains a b* value of no more than 3.5, or no more than 3.0, or no more than 2.5 after exposure to TCCA or SBS composition for 8 weeks in a 38° C. and 80% RH atmosphere.

29. The water soluble nonwoven web of any one paragraphs 1 to 28, wherein the nonwoven web maintains an average elongation of at least 90%, or at least 100%, or at least 120%, or at least 150%, or at least 175%, or at least 200%, after exposure to a TCCA or SBS composition for 8 weeks in a 38° C. and 80% RH atmosphere.

30. A water soluble unit dose article comprising a packet comprising an outer wall, the outer wall having an exterior surface and an interior surface defining an interior pouch volume, the outer wall comprising a water soluble nonwoven web according to any one of the preceding paragraphs; and a composition contained in the interior pouch volume.

31. The water soluble unit dose article of paragraph 30, wherein the composition comprises a harsh chemical.

32. The water soluble unit dose article of paragraph 31, wherein the harsh chemical comprises an acid, an oxidant, a base, or a combination thereof.

33. The water soluble unit dose article of paragraph 32, wherein the harsh chemical is a chlorine liberating compound.

34. The water soluble unit dose article of paragraph 32, wherein the acid comprises sodium bisulfate, cyanuric acid, dichloroisocyanuric acid, trichloroisocyanuric acid, citric acid, muriatic acid, or a combination thereof.

35. The water soluble unit dose article of paragraph 32 or 33, wherein the oxidant comprises hypochlorous acid, a hypochlorite, a halogenated isocyanurate, a chlorite, a chlorate, a perchlorate, a bromate, a perbromate, a halogenated hydantoin, a perborate, a periodate, a persulfate, a permanganate, a chromate, a dichromate, a nitrate, a nitrite, a peroxide, a ketone peroxide, a peroxy acid, an inorganic acid, or a combination thereof.

36. The water soluble unit dose article of paragraph 32, wherein the base comprises sodium carbonate, sodium bicarbonate, or a combination thereof.

37. The water soluble unit dose article of any one of paragraphs 31 to 36, wherein the composition is a non-household care composition.

38. The water soluble unit dose article of paragraph 37, wherein the non-household care composition is selected from the group consisting of an agricultural composition, an aviation composition, a food and nutritive composition, an industrial composition, a livestock composition, a marine composition, a medical composition, a mercantile composition, a military and/or quasi-military composition, an office composition, a recreational and/or park composition, a pet composition, a pool and/or water-treatment composition, and a combination thereof.

39. The water soluble unit dose article of paragraph 38, wherein the non-household care composition is a pool and/or water-treatment composition.

40. The water soluble unit dose article of paragraph 38 or 39, wherein the concentration of acid, oxidant, base, or combination thereof in the non-household care composition is in a range of 50 wt % to 100 wt %, or 60 wt % to 100 wt %, or 70 wt % to 100 wt %, or 80 wt % to 100 wt %, or 90 wt % to 100 wt %, based on the total weight of the non-household care composition

41. The water soluble unit dose article of any one of paragraphs 30 to 40, wherein the packet further comprises a first coating comprising an acid scavenger, an antioxidant, or both, the first coating being in contact with the outer wall.

42. The water soluble unit dose article of paragraph 41, wherein the first coating comprising an acid scavenger, an antioxidant, or a combination thereof, and is provided on at least a portion of the interior surface of the outer wall.

43. The water soluble unit dose article of paragraph 41 or 42, wherein the packet further comprises a second coating comprising an acid scavenger, an antioxidant, or both.

44. The water soluble unit dose article of paragraph 43 wherein the first coating is provided on at least a portion of the interior surface of the outer wall and the second coating is provided on at least a portion of the exterior surface of the pouch.

45. The water soluble unit dose article of any one of paragraphs 41 to 44, wherein the acid scavenger comprises N-vinyl pyrrolidone, sodium metabisulfite, zinc oxide, hydrotalcite, metallic stearate, activated olefins, allylic compounds, carboxylate compounds, ethylene containing compounds, quaternary ammonium compounds, tertiary amine containing compounds, or a combination thereof.

46. The water soluble unit dose article of any one of paragraphs 41 to 45, wherein the antioxidant comprises propyl gallate, gallic acid, phenolic compounds, hindered amines, sodium metabisulfite, zinc acetate, or a combination thereof.

47. A water soluble unit dose article comprising a water soluble nonwoven web according to any one of paragraphs 1 to 29 in the form of a packet having an outer wall having an exterior surface and an interior surface defining an interior pouch volume and a pool and/or water-treatment composition contained in the interior pouch volume, the concentration of the harsh chemical in the pool and/or water treatment composition is in a range of 50% to 100% by weight and wherein the packet optionally comprises a first coating comprising an acid scavenger provided on at least a portion of the interior surface of the outer wall.

48. A process for dosing a composition to bulk water comprising the steps of: contacting with the bulk water a water soluble unit dose article according to any one of paragraphs 30 to 47.

### Elongation Test

Elongation at break can be analyzed according to ASTM D 882. Briefly, an INSTRON® tensile testing apparatus (Model 5544 Tensile Tester or equivalent) is used for the collection of film data. A minimum of three test specimens, each cut with reliable cutting tools to ensure dimensional stability and reproducibility, are tested in the machine direction (MD) (where applicable) for each measurement. Tests are conducted in the standard laboratory atmosphere of 23±2.0° C. and 35±5% relative humidity. 1″-wide (2.54 cm) samples of a single film sheet having a thickness of 3.0±0.15 mil (or 76.2±3.8 μm) are prepared. The sample is then transferred to the INSTRON® tensile testing machine to proceed with testing. The tensile testing machine is prepared according to manufacturer instructions, equipped with a 500 N load cell, and calibrated. The correct grips and faces are fitted (INSTRON® grips having model number 2702-032 faces, which are rubber coated and 25 mm wide, or equivalent). The samples are mounted into the tensile testing machine pulled at a rate of 508 mm/minute until a 10% drop in tensile stress. The elongation at which the 10% drop in tensile stress occurs is the elongation at break.

Suitable behavior of films according to the disclosure is marked by elongation values of at least about 90% as measured by the INSTRON® testing machine. In various embodiments, the film has an elongation value of at least 90%, at least 100%, at least 120%, at least 150%, at least 175%, or at least 200% after exposure to a TCCA or SBS composition for 8 weeks in a 38° C. and 80% RH atmosphere.

### Dissolution, Disintegration, and % Residue Test (MSTM 205)

A nonwoven web can be characterized by or tested for Dissolution Time and Disintegration Time according to the MonoSol Test Method 205 (MSTM 205), a method known in the art. See, for example, U.S. Pat. No. 7,022,656.

Apparatus and Materials:

600 mL Beaker

Magnetic Stirrer (Labline Model No. 1250 or equivalent)

Magnetic Stirring Rod (5 cm)

Thermometer (0 to 100° C.±1° C.)

Template, Stainless Steel (3.8 cm×3.2 cm)

Timer (0-300 seconds, accurate to the nearest second)

Polaroid 35 mm slide Mount (or equivalent)

MonoSol 35 mm Slide Mount Holder (or equivalent)

Distilled water

For each nonwoven web to be tested, three test specimens are cut from a nonwoven web sample that is a 3.8 cm×3.2 cm specimen. If cut from a nonwoven web, specimens should be cut from areas of web evenly spaced along the traverse direction of the web. Each test specimen is then analyzed using the following procedure.

Lock each specimen in a separate 35 mm slide mount.

Fill beaker with 500 mL of distilled water. Measure water temperature with thermometer and, if necessary, heat or cool water to maintain temperature at 20° C. (about 68° F.).

Mark height of column of water. Place magnetic stirrer on base of holder. Place beaker on magnetic stirrer, add magnetic stirring rod to beaker, turn on stirrer, and adjust stir speed until a vortex develops which is approximately one-fifth the height of the water column. Mark depth of vortex.

Secure the 35 mm slide mount in the alligator clamp of the 35 mm slide mount holder such that the long end of the slide mount is parallel to the water surface. The depth adjuster of the holder should be set so that when dropped, the end of the clamp will be 0.6 cm below the surface of the water. One of the short sides of the slide mount should be next to the side of the beaker with the other positioned directly over the center of the stirring rod such that the nonwoven web surface is perpendicular to the flow of the water.

In one motion, drop the secured slide and clamp into the water and start the timer. Disintegration occurs when the nonwoven web breaks apart. When all visible nonwoven web is released from the slide mount, raise the slide out of the water while continuing to monitor the solution for undissolved nonwoven web fragments. Dissolution occurs when all nonwoven web fragments are no longer visible and the solution becomes clear.

After 300 seconds, if any nonwoven web residue remained in the frame, the percent of surface area of the nonwoven web remaining was estimated by visual inspection.

The results should include the following: complete sample identification; individual and average disintegration and dissolution times; and water temperature at which the samples were tested.

Nonwoven web disintegration times (I) and nonwoven web dissolution times (I) can be corrected to a standard or reference nonwoven web thickness using the exponential algorithms shown below in Equation 1 and Equation 2, respectively.

I_{corrected}=I_{measured}×(reference thickness/measured thickness)^{1.93} [1]

S_{corrected}=S_{measured}×(reference thickness/measured thickness)^{1.83} [2]

CIELab Test

The CIELab Test is used to determine the reference yellowness of a sample using a Ci7600 Spectrophotometer or equivalent.

### Equipment and Material(s) Required

X-Rite Ci7600 Benchtop Spectrophotometer

X-Rite Color Master Software

Black Trap, for reflectance calibration

Aperture Plate, with white ring

Sample Holder

Transmission Plaque, to cover reflectance aperture plate when completing transmission measurements

White Calibration Tile, to cover reflectance aperture plate when completing calibration

Scissors, for cutting out film samples

### Calibration of the Ci7600 Spectrophotometer

Note the aperture plates with a white ring on the inside MUST be used for transmission measurements. Open the Color Master software found on the desktop. In the Color Master software, go to the “Instrument” tab. Click Calibrate. Place the white calibration tile over the aperture plate. The UV setting should be set to EXC400. Close the transmission cover by lifting up on the locking pin while sliding the cover to the front. Note: You should hear the pin click into place. Click “OK” in the software calibration prompt. Remove the tile from the aperture plate. Take out the black trap from the accessory drawer and position it onto the aperture plate. Make sure the transmission cover is still closed and click “OK” in the software calibration prompt. Remove the black trap from the aperture plate. Place the transmission plaque over the aperture plate. Once the calibration process is successful, the calibration LED should be green.

### Creating a Standard (for Transmission Measurements)

Be sure that an aperture plate with a white ring is being used. Place the sample clamp inside instrument. Place the transmission plaque over the aperture plate. Select the “Instrument” tab. Click on “Create Standard”. Select “Take a measurement using the attached instrument” and hit “Next”. Select if you want an average of measurements and indicate the number of measurements taken. Example: three measurements are taken for an average. Place a 2×2 sample in the transmission sample clamp. Close the transmission cover by lifting up on the locking pin while sliding the cover to the front. Click on “Measure” and repeat for each sample. Click “Next.” Type in a name for the standard. Type in a description for the standard if you choose. Click “Next.” If you want to change the tolerance or the Illuminant/Observer specifications, click on “Modify” and make the desired changes. Otherwise, select “Next.” Select “No” when prompted to enter in shade sorting data and select “Next.” Select “Finish”.

### Selecting a Standard (for Transmission Measurements)

Select the “Database” tab. Click on “Find Standard”. Click the appropriate standard needed. Standard should be highlighted in blue. Then press “Select”. Standard is ready to use. To double check the right standard was selected, check the control box in the upper left-hand corner in the program. This box should read the appropriate standard selected.

### Measuring Samples (for Transmission)

Mount the appropriate aperture plate (with white reflective ring) to the measurement port at the front of the instrument. Place the white cap over the aperture plate. Attach the sample clamp and stop to the base with the thumb screws. Select the “Instrument” tab. Click on “Measure Trial.” In the bottom left-hand side of the screen, a window will pop up with the name of the standard being used. Move this window up so that it can be seen on the screen. Change the specifications as needed, such as displaying SPIN (specular reflectance included) or SPEX (specular reflectance excluded) measurements and the illuminant/observer specification. Change the configuration to match picture below by click the hyperlink under “Haze”. Next to “Lot I.D.” type in the sample name for the sample that is being measured. Center the 2 in×2 in sample in the transmission sample holder and place between the stop and clamp toward the sphere. Always make certain that the sample is flush and parallel to the opening in the sphere. Close the cover. Hit F8 on the keyboard or click on the right corner of “Measure” to make the measurement. You should hear a clicking noise and see a flash when measuring. Once the measurement is complete, remove the sample from the sample holder. If there is another sample, place it onto the sample holder. Continue until all samples have been measured. Wait approximately 1 minute between sample measurements. Once measurements are complete, exit out of the “Measure Trial” window.

### Reporting of Test Results

The numerical data that is given is in terms of the CIE L*a*b* color measurement system. These values represent various aspects of an object's color. The L value quantifies how light or dark the color is, with black and white being the two ends. The a value quantifies how red or green the color is, with a positive a value being more red and a negative a value being more green. The b value quantifies how yellow or blue the color is, with a positive b value being more yellow and a negative b value being more blue. Record the Spex numerical data that is given of the L*a*b* color measurements under F12/10 light source.

### EXAMPLES

### Example 1— Exposure of PVOH Nonwoven Webs to Harsh Chemicals

Water soluble nonwoven webs comprising fibers of sulfonate modified PVOH or PVOH homopolymers were formed into pouches comprising trichloroisocyanuric acid (“TCCA”) and/or calcium hypochlorite (“Cal Hypo”). The pouches were stored in secondary packaging prepared from a 4 mil HDPE film for 6 weeks at a temperature of 38° C. and 80% RH. The dissolution, disintegration, and/or % residue were measured according to MSTM 205, the yellowness was measured according to CIELab Test, and the elongation % was measured according to the Elongation Test. The results are provided in Table 1, below.

Dissolution/Disintegration: Samples were measured at 0 weeks, 2 weeks, 4 weeks, and 6 weeks, time points unless the nonwoven webs failed to dissolve or disintegrate at 0, 2, or 4 weeks, at which point testing was discontinued. A shorter dissolution or disintegration time indicated that the nonwoven was more stable to the harsh chemical, and a longer dissolution or disintegration time at 6 weeks indicated the nonwoven was less stable to the harsh chemical.

| | | | | | | Tensile | | | |
|---|---|---|---|---|---|---|---|---|---|
| Fiber Forming | | Exposure | Gauge | Disintegration | Dissolution | Strength | Elongation | Color | Pass/Fail |
| Material | Chemical | (wks) | (um) | (s) | (s) | (N/mm\hat{ }2) | (%) | b* | Disintegration |
| 2 mol % AMPS, | No | 0 | 177 | 21 | 35 | 4.5 | 25.02 | 1.91 | P |
| 99 + % DH PVOH | Chemical | | | | | | | | |
| 2 mol % AMPS, | No | 0 | 174 | 18 | 37 | 4.57 | 4.54 | 1.91 | P |
| 99 + % DH PVOH | Chemical | | | | | | | | |
| 2 mol % AMPS, | No | 0 | 177 | 18 | 35 | 4.28 | 6.26 | 1.9 | P |
| 99 + % DH PVOH | Chemical | | | | | | | | |
| 2 mol % AMPS, | TCCA | 2 | 278 | >300 | >300 | 2.19 | 94.93 | 6.3 | F |
| 99 + % DH PVOH | | | | | | | | | |
| 2 mol % AMPS, | TCCA | 2 | 264 | >300 | >300 | 0.48 | 72.17 | 6.77 | F |
| 99 + % DH PVOH | | | | | | | | | |
| 2 mol % AMPS, | TCCA | 2 | 258 | >300 | >300 | 0.34 | 71.84 | 6.85 | F |
| 99 + % DH PVOH | | | | | | | | | |
| 2 mol % AMPS, | Cal Hypo | 2 | 149.86 | 55 | >300 | 3.3 | 12.34 | 2.62 | P |
| 99 + % DH PVOH | | | | | | | | | |
| 2 mol % AMPS, | Cal Hypo | 2 | 149.86 | 56 | >300 | 3.16 | 20.89 | 2.51 | P |
| 99 + % DH PVOH | | | | | | | | | |
| 2 mol % AMPS, | Cal Hypo | 2 | 149.86 | 55 | >300 | 1.88 | 10.15 | 2.51 | P |
| 99 + % DH PVOH | | | | | | | | | |
| 2 mol % AMPS, | Cal Hypo | 4 | 149.86 | 41 | >300 | 4.31 | 7.6 | 2.88 | P |
| 99 + % DH PVOH | | | | | | | | | |
| 2 mol % AMPS, | Cal Hypo | 4 | 149.86 | 82 | >300 | 3.07 | 17.96 | 2.73 | P |
| 99 + % DH PVOH | | | | | | | | | |
| 2 mol % AMPS, | Cal Hypo | 4 | 149.86 | 68 | >300 | 2.43 | 34.36 | 2.7 | P |
| 99 + % DH PVOH | | | | | | | | | |
| 2 mol % AMPS, | Cal Hypo | 6 | 182.88 | 86 | >300 | 3.71 | 7 | 2.78 | P |
| 99 + % DH PVOH | | | | | | | | | |
| 2 mol % AMPS, | Cal Hypo | 6 | 182.88 | 64 | >300 | 3.06 | 10.28 | 2.69 | P |
| 99 + % DH PVOH | | | | | | | | | |
| 2mol % AMPS,\ | Cal Hypo | 6 | 172.72 | 101 | >300 | 6.53 | 7.81 | 2.78 | P |
| 99 + % DH PVOH | | | | | | | | | |
| PVOH | No | 0 | 90.17 | 20 | 53 | | | 1.86 | P |
| homopolymer 23 | Chemical | | | | | | | | |
| cps, 88% DH | | | | | | | | | |
| PVOH | No | 0 | 92.71 | 18 | 58 | | | | P |
| homopolymer 23 | Chemical | | | | | | | | |
| cps, 88% DH | | | | | | | | | |
| PVOH | No | 0 | 86.36 | 18 | 57 | | | | P |
| homopolymer 23 | Chemical | | | | | | | | |
| cps, 88% DH | | | | | | | | | |
| PVOH | TCCA | 2 | 172.72 | >300 | >300 | 5.67 | 16.65 | 17.66 | F |
| homopolymer 23 | | | | | | | | | |
| cps, 88% DH | | | | | | | | | |
| PVOH | TCCA | 2 | 157.48 | >300 | >300 | 4.79 | 16.55 | 16.63 | F |
| homopolymer 23 | | | | | | | | | |
| cps, 88% DH | | | | | | | | | |
| PVOH | TCCA | 2 | 175.26 | >300 | >300 | 5.45 | 19.02 | 18.36 | F |
| homopolymer 23 | | | | | | | | | |
| cps, 88% DH | | | | | | | | | |

The water-soluble nonwoven webs were prepared using fibers comprising either 2 mol % AMPS modified PVOH having a 99+% degree of hydrolysis or PVOH homopolymers having a viscosity of 23 cPs and a degree of hydrolysis of about 88 as the sole fiber forming material component to determine the effect of the harsh chemical on various PVOH resins, as seen in Table 1. It was found that in general, AMPS modified PVOH fibers and PVOH homopolymer fibers were found to have poor dissolution and after exposure to an acid-mediated oxidants (i.e., TCCA) for 2 weeks at a temperature of 38° C. and 80% RH. However, AMPS modified PVOH fibers were surprisingly found to have acceptable disintegration (e.g. the nonwoven web disintegrates in less than 300 seconds according to MSTM 205) and acceptable discoloration (e.g., the nonwoven web has a color b* value of less than 3.5 and even less than 3.0 according to the CIELab Test) after 2 weeks, 4 weeks, and even 6 weeks of being exposed to a base-mediated oxidant (e.g., calcium hypochlorite).

The foregoing description is given for clearness of understanding only, and no unnecessary limitations should be understood therefrom, as modifications within the scope of the invention may be apparent to those having ordinary skill in the art.

All patents, publications and references cited herein are hereby fully incorporated by reference. In case of conflict between the present disclosure and incorporated patents, publications and references, the present disclosure should control.

1. A unit dose article comprising a packet comprising:
an outer wall, the outer wall having an exterior surface and an interior surface defining an interior pouch volume, the outer wall comprising a nonwoven web comprising a plurality of fibers, the plurality of fibers comprising:
(a) a sulfonate modified polyvinyl alcohol (PVOH) fiber forming material comprising a sulfonated anionic monomer unit, wherein the sulfonate modified PVOH fiber forming material has a degree of hydrolysis of at least 95% and the sulfonated anionic monomer unit is present in an amount in a range of about 1 mol % to about 5 mol %; or
(b) a blend of fiber forming materials comprising:
(i) polyvinylpyrrolidone; and
(ii) a modified PVOH comprising a sulfonate modified PVOH comprising a sulfonated anionic monomer unit, a carboxyl modified PVOH comprising a carboxylated anionic monomer unit, or both; and
a composition contained in the interior pouch volume.

2. The unit dose article of claim 1, wherein the sulfonated anionic monomer unit is one or more selected from the group of vinyl sulfonic acid, allyl sulfonic acid, ethylene sulfonic acid, 2-acrylamido-1-methylpropanesulfonic acid, 2-acrylamido-2-methylpropanesulfonic acid (AMPS), 2-methylacrylamido-2-methylpropanesulfonic acid, 2-sulfoethyl acrylate, and an alkali salt of the foregoing.

3. (canceled)

4. The unit dose article of claim 1, wherein the sulfonated anionic monomer is present in an amount in a range of about 1 mol % to about 3 mol %.

5. The unit dose article of claim 1, wherein:
(a) the plurality of fibers further comprises a fiber comprising cellulose, starch, a carboxyl modified PVOH comprising a carboxylated anionic monomer unit, or a combination thereof, or
(b) the plurality of fibers comprising the sulfonate modified PVOH fiber forming material further comprises a fiber forming material comprising, cellulose, starch, polyvinylpyrrolidone, a carboxyl modified PVOH comprising a carboxylated anionic monomer unit, or a combination thereof, or
(c) a combination of (a) and (b).

6. The unit dose article of claim 1, wherein the nonwoven web further comprises at least one or more of the following: an acid scavenger, an antioxidant, a plasticizer, a filler, or a surfactant.

7. (canceled)

8. The unit dose article of claim 6, wherein the at least one or more of the acid scavenger, the antioxidant, the plasticizer, the filler, or the surfactant is provided in or on at least one fiber of the plurality of fibers, in or on the nonwoven web, coated on at least one fiber of the plurality of fibers, coated on the nonwoven web, dispersed throughout the nonwoven web, or a combination of the foregoing.

9. (canceled)

10. (canceled)

11. The unit dose article of claim 1, wherein the nonwoven web further comprises an antioxidant comprising one or more selected from the group of propyl gallate, gallic acid, a phenolic compound, a hindered amine, sodium metabisulfite, and zinc acetate.

12.-15. (canceled)

16. The unit dose article of claim 1, wherein the nonwoven web further comprises a plasticizer comprising one or more selected from the group of glycerin, diglycerin, sorbitol, ethylene glycol, diethylene glycol, triethylene glycol, dipropylene glycol, tetraethylene glycol, propylene glycol, polyethylene glycols up to 400 MW, neopentyl glycol, trimethylolpropane, polyether polyols, 2-methyl-1,3-propanediol, ethanolamines, and maltitol.

17. (canceled)

18. (canceled)

19. The unit dose article of claim 1, wherein the nonwoven web further comprises a filler comprising one or more selected from the group of high amylose starch, amorphous silica, and hydroxyethylated starch.

20. (canceled)

21. The unit dose article of claim 1, wherein the nonwoven web further comprises a surfactant comprising one or more of the group of a quaternary amine, myristyl dimethyl amine oxide, alkyl polyethylene glycol ether, and a cocamide.

22. (canceled)

23. The unit dose article of claim 1, wherein the nonwoven web has a disintegration time of no more than 300 seconds according to MSTM 205 in 23° C. water after exposure to calcium hypochlorite for 6 weeks in a 38° C. and 80% RH atmosphere.

24. The unit dose article of claim 1, wherein the nonwoven web maintains a b* value of not more than 3.5, or no more than 3.0, or no more than 2.5 after exposure to calcium hypochlorite for 6 weeks in a 38° C. and 80% RH atmosphere.

25. The unit dose article of claim 1, wherein the composition comprises a harsh chemical an oxidant, a base, or a combination thereof.

26. (canceled)

27. The unit dose article of claim 25, wherein the oxidant is a chlorine liberating compound.

28. The unit dose article of claim 26, wherein the oxidant comprises one or more of hypochlorous acid, a hypochlorite, a halogenated isocyanurate, a chlorite, a chlorate, a perchlorate, a bromate, a perbromate, a halogenated hydantoin, a perborate, a periodate, a persulfate, a permanganate, a chromate, a dichromate, a nitrate, a nitrite, a peroxide, a ketone peroxide, a peroxy acid, and an inorganic acid.

29. The unit dose article of claim 25, wherein the chemical oxidant comprises a base-mediated oxidant.

30. The unit dose article of claim 29, wherein the base-mediated oxidant comprises a hypochlorite.

31. The unit dose article of claim 25, wherein the base comprises one or more of sodium carbonate and sodium bicarbonate.

32. The unit dose article of claim 1, wherein the composition comprises one or more selected from the group of an agricultural composition, an aviation composition, a food and nutritive composition, an industrial composition, a livestock composition, a marine composition, a medical composition, a mercantile composition, a military and/or quasi-military composition, an office composition, a recreational and/or park composition, a pet composition, and a pool and/or water-treatment composition.

33. (canceled)

34. (canceled)

35. The unit dose article of claim 25, wherein the oxidant, the base, or the combination thereof has a concentration in a range of 50 wt % to 100 wt % based on a total weight of the composition.

36. The unit dose article of claim 1, wherein the packet further comprises a first coating comprising an acid scavenger, an antioxidant, or both, the first coating being in contact with the outer wall.

37. The unit dose article of claim 36, wherein the first coating is provided on at least a portion of the interior surface of the outer wall.

38. The unit dose article of claim 36 or 37, wherein the packet further comprises a second coating comprising an acid scavenger, an antioxidant, or both.

39. The unit dose article of claim 38, wherein the first coating is provided on at least a portion of the interior surface of the outer wall and the second coating is provided on at least a portion of the exterior surface of the outer wall.

40. The unit dose article of claim 38, wherein the acid scavenger comprises one or more of N-vinyl pyrrolidone, sodium metabisulfite, zinc oxide, hydrotalcite, metallic stearate, an activated olefin, an allylic compound, a carboxylate compound, an ethylene containing compound, a quaternary ammonium compound, and a tertiary amine containing compound.

41. The unit dose article of claim 38, wherein the antioxidant comprises one or more of propyl gallate, gallic acid, a phenolic compound, a hindered amine, sodium metabisulfite, and zinc acetate.

42. The unit dose article of claim 1, wherein the blend of fiber forming materials comprises polyvinylpyrrolidone and the modified PVOH having a weight ratio of polyvinylpyrrolidone fiber forming material to modified PVOH fiber forming material is about 1:1 to about 1:19.

43. The unit dose article of claim 1, wherein the carboxyl modified PVOH comprises one or more maleate monomer units selected from the group of monomethyl maleate, maleic acid, maleic anhydride, and an alkali salt thereof.

44. The unit dose article of claim 43, wherein the maleate monomer unit is present in an amount in a range of about 1 mol % to 10 mol %.

45. The unit dose article according to of claim 1, wherein the composition comprises an oxidant, a concentration of the oxidant in the composition is in a range of 50% to 100%, the oxidant comprises calcium hypochlorite, and the packet optionally comprises a first coating comprising an acid scavenger provided on at least a portion of the interior surface of the outer wall.

46. The unit dose article according to claim 1, wherein the composition comprises an oxidant, a concentration of the oxidant in the composition is in a range of 50% to 100% by weight, the oxidant comprises trichloroisocyanuric acid, and the packet optionally comprises a first coating comprising an acid scavenger provided on at least a portion of the interior surface of the outer wall.

47. (canceled)
